(19) United States
(12) Patent Application Publication
(10) Pub. No.: US 2026/0340776 A1
(43) Pub. Date: Oct. 29, 2026

(54) Image Enhancement Based on Removal of Image Degradations by Learning from Multiple Machine Learning Models

(71) Applicant: Google LLC, Mountain View, CA (US)

(72) Inventors: Mauricio Delbracio, Sunnyvale, CA (US); Peyman Milanfar, Menlo Park, CA (US); Hossein Talebi, San Jose, CA (US); Sungjoon Choi, Los Altos, CA (US)

(21) Appl. No.: 19/104,099

(22) PCT Filed: Sep. 13, 2022
(86) PCT No.: PCT/US2022/076347

§ 371 Date: Feb. 14, 2025

(51) Int. Cl. G06T 5/60; G06T 5/73

(52) U.S. Cl. CPC G06T 5/60; G06T 5/73; G06T 2207/20081; G06T 2207/20084

(57) ABSTRACT

A method includes receiving an input image. The method includes predicting, by an image transformation model, a transformed version of the input image, the image transformation model having been trained to remove image degradations associated with the input image, the training having comprised (1) training of a plurality of intermediate machine learning models to remove the image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models. The method includes providing the predicted transformed version.

### BACKGROUND

Many modern computing devices, including mobile phones, personal computers, and tablets, include image capture devices, such as still and/or video cameras. The image capture devices can capture images, such as images that include people, animals, landscapes, and/or objects. Some image capture devices and/or computing devices can correct or otherwise modify captured images. For example, some image capture devices can provide “red-eye” correction that removes artifacts such as red-appearing eyes of people and animals that may be present in images captured using bright lights, such as flash lighting. After a captured image has been corrected, the corrected image can be saved, displayed, transmitted, printed to paper, and/or otherwise utilized.

### SUMMARY

Removing blur, noise and compression artifacts from images are longstanding problems in computational photography. Image degradations can come from several sources. When the photographer or the autofocus system incorrectly sets the focus (out-of-focus), or when the relative motion between the camera and the scene is faster than the shutter speed (motion blur). Additionally, even in ideal acquisition conditions, there can be an intrinsic camera blur due to sensor resolution, light diffraction, lens aberrations, and anti-aliasing filters. Similarly, image noise is intrinsic to the capture of a discrete number of photons (shot-noise), and the analog-digital conversion and processing (read out noise). In general, images are compressed, such as by using JPEG compression, before storage or transmission. The image compression can also degrade the image quality.

Powered by a system of machine-learned components, an image capture device may be configured to enable users to remove blur, noise, compression artifacts, and so forth, to create sharp images. In some aspects, mobile devices may be configured with these features so that an image can be enhanced in real-time. In some instances, an image may be automatically enhanced by the mobile device. In other aspects, mobile phone users can non-destructively enhance an image to match their preference. Also, for example, pre-existing images in a user's image library can be enhanced based on techniques described herein.

In one aspect, a computer-implemented method is provided. The method includes receiving, by a computing device, a plurality of training datasets corresponding to a respective plurality of degradation factors, wherein each training dataset comprises a plurality of pairs of sharp images and corresponding synthetically degraded versions of the sharp images. The method also includes training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors. The method additionally includes training, on an additional training dataset of real images, an image transformation model to remove the one or more image degradations associated with the real images, wherein the image transformation model learns from the plurality of intermediate machine learning models. The method further includes outputting, by the computing device, the trained image transformation model for removal of image degradations.

In another aspect, a computing device is provided. The computing device includes one or more processors and data storage. The data storage has stored thereon computer-executable instructions that, when executed by one or more processors, cause the computing device to carry out functions. The functions include: receiving, by the computing device, a plurality of training datasets corresponding to a respective plurality of degradation factors, wherein each training dataset comprises a plurality of pairs of sharp images and corresponding synthetically degraded versions of the sharp images; training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors; training, on an additional training dataset of real images, an image transformation model to remove the one or more image degradations associated with the real images, wherein the image transformation model learns from the plurality of intermediate machine learning models; and outputting, by the computing device, the trained image transformation model for removal of image degradations.

In another aspect, a computer program is provided. The computer program includes instructions that, when executed by a computing device, cause the computing device to carry out functions. The functions include: receiving, by the computing device, a plurality of training datasets corresponding to a respective plurality of degradation factors, wherein each training dataset comprises a plurality of pairs of sharp images and corresponding synthetically degraded versions of the sharp images; training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors; training, on an additional training dataset of real images, an image transformation model to remove the one or more image degradations associated with the real images, wherein the image transformation model learns from the plurality of intermediate machine learning models; and outputting, by the computing device, the trained image transformation model for removal of image degradations.

In another aspect, an article of manufacture is provided. The article of manufacture includes one or more computer readable media having computer-readable instructions stored thereon that, when executed by one or more processors of a computing device, cause the computing device to carry out functions. The functions include: receiving, by the computing device, a plurality of training datasets corresponding to a respective plurality of degradation factors, wherein each training dataset comprises a plurality of pairs of sharp images and corresponding synthetically degraded versions of the sharp images; training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors; training, on an additional training dataset of real images, an image transformation model to remove the one or more image degradations associated with the real images, wherein the image transformation model learns from the plurality of intermediate machine learning models; and outputting, by the computing device, the trained image transformation model for removal of image degradations.

In another aspect, a system is provided. The system includes means for receiving, by the computing device, a plurality of training datasets corresponding to a respective plurality of degradation factors, wherein each training dataset comprises a plurality of pairs of sharp images and corresponding synthetically degraded versions of the sharp images; means for training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors; means for training, on an additional training dataset of real images, an image transformation model to remove the one or more image degradations associated with the real images, wherein the image transformation model learns from the plurality of intermediate machine learning models; and means for outputting, by the computing device, the trained image transformation model for removal of image degradations.

In another aspect, a computer-implemented method is provided. The method includes receiving, by a computing device, an input image comprising one or more image degradations. The method also includes predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models. The method additionally includes providing, by the computing device, the predicted transformed version of the input image.

In another aspect, a computing device is provided. The computing device includes one or more processors and data storage. The data storage has stored thereon computer-executable instructions that, when executed by one or more processors, cause the computing device to carry out functions. The functions include: receiving, by a computing device, an input image comprising one or more image degradations; predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models; and providing, by the computing device, the predicted transformed version of the input image.

In another aspect, a computer program is provided. The computer program includes instructions that, when executed by a computing device, cause the computing device to carry out functions. The functions include: receiving, by a computing device, an input image comprising one or more image degradations; predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models; and providing, by the computing device, the predicted transformed version of the input image.

In another aspect, an article of manufacture is provided. The article of manufacture includes one or more computer readable media having computer-readable instructions stored thereon that, when executed by one or more processors of a computing device, cause the computing device to carry out functions. The functions include: receiving, by a computing device, an input image comprising one or more image degradations; predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models; and providing, by the computing device, the predicted transformed version of the input image.

In another aspect, a system is provided. The system includes means for receiving, by a computing device, an input image comprising one or more image degradations; means for predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models; and means for providing, by the computing device, the predicted transformed version of the input image.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1A is a diagram illustrating an example image enhancement process, in accordance with example embodiments.

FIG. 1B is a diagram illustrating an example network architecture, in accordance with example embodiments.

FIG. 2A is a diagram illustrating an example overview of a pipeline to generate synthetic data, in accordance with example embodiments.

FIG. 2B is a diagram illustrating an example training of multiple intermediate models, in accordance with example embodiments.

FIG. 2C is a diagram illustrating an example pipeline to generate a curated dataset, in accordance with example embodiments.

FIG. 2D is a diagram illustrating an example training of an image transformation model, in accordance with example embodiments.

FIG. 3 is a diagram illustrating an example pipeline to generate synthetic data, in accordance with example embodiments, in accordance with example embodiments.

FIG. 4 illustrates example motion blur kernels for different scale parameters, in accordance with example embodiments.

FIG. 5 illustrates example input and output images corresponding to a simulated motion blur, in accordance with example embodiments.

FIG. 6 illustrates example histograms relating motion kernel length as a function of a scale parameter, in accordance with example embodiments.

FIG. 7 illustrates example generalized Gaussian blur kernels, in accordance with example embodiments.

FIG. 8 illustrates example input and output images corresponding to simulated compression artifacts, in accordance with example embodiments.

FIG. 9 illustrates example images corresponding to training data generation, in accordance with example embodiments.

FIG. 10 illustrates example output images of a trained image transformation model, in accordance with example embodiments.

FIG. 11 is a diagram illustrating training and inference phases of a machine learning model, in accordance with example embodiments.

FIG. 12 depicts a distributed computing architecture, in accordance with example embodiments.

FIG. 13 is a block diagram of a computing device, in accordance with example embodiments.

FIG. 14 depicts a network of computing clusters arranged as a cloud-based server system, in accordance with example embodiments.

FIG. 15 is a flowchart of a method, in accordance with example embodiments.

FIG. 16 is a flowchart of another method, in accordance with example embodiments.

### DETAILED DESCRIPTION

Image blur can be generally modeled as a linear operator acting on a sharp latent image. For a shift-invariant linear operator, the blurring operation may amount to a convolution with a blur kernel. In practice, a common assumption is that captured images include additive noise and compression in addition to blurring. According, the following relation may apply:

v=C(S(u*k)+n), (Eqn. 1)

where v is the captured image, u is the underlying sharp image, k is the unknown blur kernel, * is a convolution operation, n is additive noise, S models the sensor non-linear response (e.g., saturation), and C represents image compression. Some existing techniques perform image deblurring by viewing the problem as a “blind” deconvolution process. For example, in the first step, a blur kernel may be estimated. This may be achieved by assuming a sharp image model, for example, by using a variational framework, while in a second independent step a “non-blind” deconvolution algorithm may be applied. However, image noise and artifacts resulting from compression may negatively impact both steps. Even in the case where the blur kernel may be determined, “non-blind” deconvolution may be an ill-posed problem, and the presence of noise, compression, and so forth, may lead to artifacts. A significant drawback of model-based deblurring is that the degradation model generally has to have a high degree of accuracy. This may pose significant challenges in practice, due to several unknown, or partially known image transformations (e.g., unknown blur, unknown camera image signal processor (ISP), post-processing, compression, and so forth).

This application relates to enhancing an image, using machine learning techniques, such as but not limited to neural network techniques. When a mobile computing device user captures an image, the resulting image may have one or more image degradations due to motion blur, lens blur, pixel saturation, image compression, and so forth. As such, an image-processing-related technical problem arises that involves removing the one or more image degradations to generate a sharp image.

To remove the one or more image degradations, the herein-described techniques apply a model based on a convolutional neural network to predict a sharp image. The herein-described techniques include receiving an input image and predicting an output image that is a sharper version of the input image using the convolutional neural network, and generating an output based on the output image. The input and output images can be high-resolution images, such as multi-megapixel images captured by a camera of a mobile computing device. The convolutional neural network can work well with input images captured under a variety of photography conditions, including different cameras, different objects and scenes, different lighting environments, and so forth. In some examples, a trained model of the convolutional neural network can work on a variety of computing devices, including but not limited to, mobile computing devices (e.g., smart phones, tablet computers, cell phones, laptop computers), stationary computing devices (e.g., desktop computers), and server computing devices. The convolutional neural network can apply an image transformation model to an input image, thereby removing the one or more image degradations and solving the technical problem of obtaining a sharper version (e.g., higher visual perception quality) of an already-obtained image.

A neural network, such as a convolutional neural network, can be trained using a training data set of images to perform one or more aspects as described herein. In some examples, the neural network can be arranged as an encoder/decoder neural network.

As described herein, a Deep Motion, Out-of-focus, and Degradation Enhancement (DeepMode) model can be applied to challenging cases, where blur is moderate/large and where the image presents other degradations, such as noise or JPEG compression artifacts.

DeepMode may be configured to be a supervised deep-learning end-to-end solution to eliminate blur, noise, compression artifacts, and so forth, on images.

In one example, (a copy of) the trained neural network can reside on a mobile computing device. The mobile computing device can include a camera that can capture an input image. A user of the mobile computing device can view the input image and determine that the input image should be sharpened. The user can then provide the input image to the trained neural network residing on the mobile computing device. In response, the trained neural network can generate a predicted output image that is a sharper version of the input image, and subsequently output the output image (e.g., provide the output image for display by the mobile computing device). In other examples, the trained neural network is not resident on the mobile computing device; rather, the mobile computing device provides the input image to a remotely-located trained neural network (e.g., via the Internet or another data network). The remotely-located convolutional neural network can process the input image and provide an output image that is a sharper version of the input image to the mobile computing device. In other examples, non-mobile computing devices can also use the trained neural network to sharpen images, including images that are not captured by a camera of the computing device.

In some examples, the trained neural network can work in conjunction with other neural networks (or other software) and/or be trained to recognize whether an input image has image degradations. Then, upon a determination that an input image has image degradations, the herein-described trained neural network could apply the trained neural network, thereby removing the image degradations in the input image.

As such, the herein-described techniques can improve images by removing image degradations, thereby enhancing their actual and/or perceived quality. Enhancing the actual and/or perceived quality of images, including portraits of people, can provide emotional benefits to those who believe their pictures look better. These techniques are flexible, and so can apply to images of human faces and other objects, scenes, and so forth.

### Network Architecture

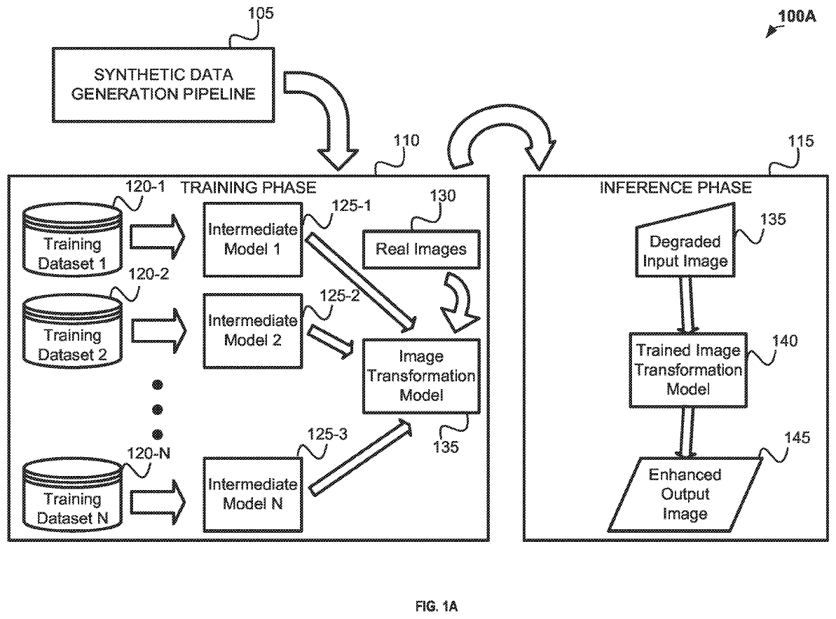

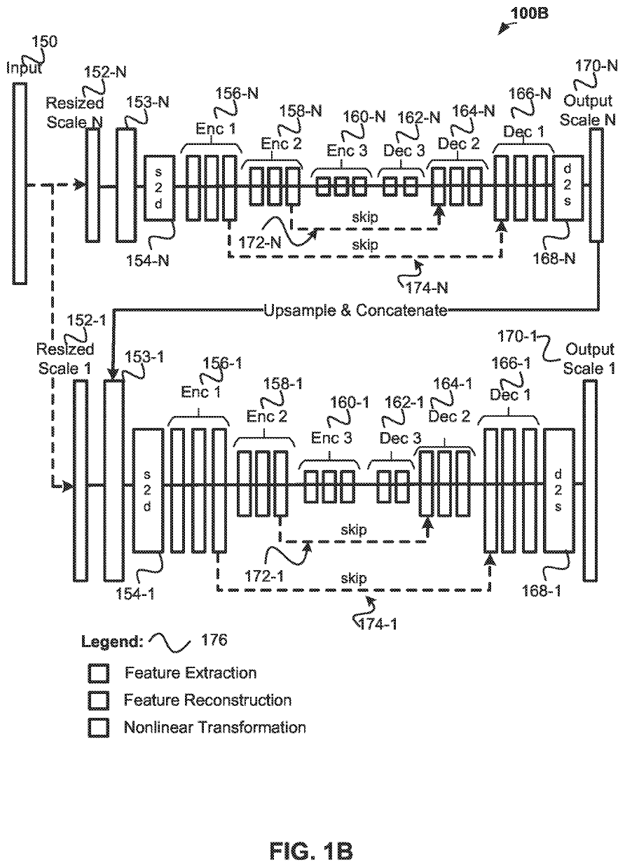

FIG. 1A is a diagram illustrating an example image enhancement process 100A, in accordance with example embodiments. In this example, a relation between a synthetic data generation pipeline 105, a training phase 110, and an inference phase 115, is illustrated. Details for each of these different aspects are provided in greater detail below. Some embodiments involve receiving, by a computing device, a plurality of training datasets corresponding to a respective plurality of degradation factors. Each training dataset may include a plurality of pairs of sharp images and corresponding synthetically degraded versions of the sharp images. For example, synthetic data generation pipeline 105 may be configured to generate synthetic data that includes images with image degradations. For example, image degradations may be synthetically introduced into sharp images based on the plurality of degradation factors. For example, synthetic data generation pipeline 105 may be configured to generate a plurality of training datasets 120-1, 120-2, . . . , 120-N. In some embodiments, each training dataset may correspond to a particular degradation factor (and different training datasets may correspond to different degradation factors). Each training dataset may include a plurality of pairs of sharp images and corresponding synthetically degraded versions of the sharp images.

The term “degradation factor” as used herein, generally refers to any factor that affects a sharpness of an image, such as, for example, a clarity of the image with respect to quantitative image quality parameters such as contrast, focus, and so forth. In some embodiments, the plurality of degradation factors may include one or more of a motion blur, a lens blur, an image noise, an image compression artifact, or an artifact caused by saturated pixels.

The term “motion blur” as used herein, generally refers to a degradation factor that causes one or more objects in an image to appear vague, and/or indistinct due to a motion of a camera capturing the image, a motion of the one or more objects, or a combination of the two. In some examples, a motion blur may be perceived as streaking or smearing in the image. The term “lens blur” as used herein, generally refers to a degradation factor that causes an image to appear to have a narrower depth of field than the scene being captured. For example, certain objects in an image may be in focus, whereas other objects may appear out of focus.

The term “image noise” as used herein, generally refers to a degradation factor that causes an image to appear to have artifacts (e.g., specks, color dots, and so forth) resulting from a lower signal-to-noise ratio (SNR). For example, an SNR below a certain desired threshold value may cause image noise. In some examples, image noise may occur due to an image sensor, or a circuitry in a camera. The term “image compression artifact” as used herein, generally refers to a degradation factor that results from lossy image compression. For example, image data may be lost during compression, thereby resulting in visible artifacts in a decompressed version of the image.

The term “saturated pixels” as used herein, generally refers to a condition where pixels are saturated with photons, and the photons then spill over into adjacent pixels. For example, a saturated pixel may be associated with an image intensity of higher than a threshold intensity (e.g., higher than 245, or at 255, and so forth). Image intensity may correspond to an intensity of a grayscale, or an intensity of a color component in red, blue, or green (RGB). For example, highly saturated pixels may appear as brightly colored. Accordingly, the spilling over of photons from saturated pixels into adjacent pixels may cause perceptive defects in an image (for example, causing a saturation of one or more adjacent pixels, distorting the intensity of the one or more adjacent pixels, and so forth).

Generating different training datasets (e.g., plurality of training datasets 120-1, 120-2, . . . , 120-N) enables a tailored approach to training machine learning models to remove particular image degradations. For example, during training phase 110, a plurality of intermediate machine learning models 125-1, 125-2, . . . , 125-N may be trained to remove the one or more image degradations associated with a given image. For example, during training phase 110, each intermediate machine learning model of the plurality of intermediate machine learning models 125-1, 125-2, . . . , 125-N may be trained on a respective training dataset of the plurality of training datasets 120-1, 120-2, . . . , 120-N, to remove the one or more image degradations associated with the given image, based on the respective plurality of degradation factors.

Some embodiments involve training, on an additional training dataset of real images, an image transformation model to remove the one or more image degradations associated with the real images, wherein the image transformation model learns from the plurality of intermediate machine learning models. For example, image transformation model 135 may be trained based on the additional training dataset 130 of real images by learning from the plurality of trained intermediate machine learning models 125-1, 125-2, . . . , 125-N. Additional training dataset 130 may include real images with one or more image degradations caused by one or more degradation factors. Since each intermediate machine learning model has been trained to remove image degradations caused by a particular degradation factor, image transformation model 135 may be trained to leverage the plurality of trained intermediate machine learning models 125-1, 125-2, . . . , 125-N to remove arbitrary image degradations in real images from the additional training dataset 130.

Some embodiments involve outputting, by the computing device, the trained image transformation model for removal of image degradations. For example, upon completion of training phase 110, the trained image transformation model 135 may be provided to be utilized, for example, in inference phase 115.

Some embodiments involve receiving, by a computing device, an input image comprising one or more image degradations. For example, during inference phase 115, a degraded input image 135 may be received. The term “degraded image” as used herein, generally refers to an image that has one or more image degradations caused by one or more degradation factors.

Some embodiments involve predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models.

For example, trained transformation neural network 140 may take as input, the degraded input image 135. As previously described, trained transformation neural network 140 may have been trained, during training phase 110, to remove the one or more image degradations associated with the degraded input image 135, and the training may have included training of the plurality of intermediate machine learning models 125-1, 125-2, . . . , 125-N to remove the one or more image degradations, each intermediate machine learning model of the plurality of intermediate machine learning models 125-1, 125-2, . . . , 125-N having been trained on a respective training dataset of a plurality of training datasets 120-1, 120-2, . . . , 120-N corresponding to a respective plurality of degradation factors, each training dataset having comprised a plurality of pairs of sharp images and corresponding synthetically degraded versions of the sharp images.

Some embodiments involve providing, by the computing device, the predicted transformed version of the input image. For example, trained transformation neural network 140 may transform the degraded input image 135 to predict a transformed version, enhanced output image 145. Generally, the enhanced output image 145 represents a version of the degraded input image 135 where the one or more image degradations associated with the degraded input image 135 have been removed.

In some embodiments, the plurality of intermediate machine learning models may be teacher networks, wherein the image transformation model may be a student network, and wherein the image transformation model learns from the plurality of intermediate machine learning models based on knowledge distillation. Generally, knowledge distillation is a teacher-student training process that may be used to train a smaller (or lighter), and generally more precise, network based on heavier pre-trained teacher networks. For example, the heavier pre-trained teacher networks may reside on a cloud server (typically associated with greater computational resources), and the smaller (or lighter) network may be configured to operate on a mobile device (typically with associated limits on computational resources). For example, the plurality of intermediate machine learning models 125-1, 125-2, . . . , 125-N may be teacher networks, and the image transformation model 145 may be a student network that is trained on respective outputs of the plurality of intermediate machine learning models 125-1, 125-2, . . . , 125-N. In some embodiments, the plurality of intermediate machine learning models 125-1, 125-2, . . . , 125-N may be of different sizes, and the image transformation model 145 may be trained to optimize prediction quality with a lower prediction runtime.

One or more of the plurality of intermediate machine learning models or the image transformation model may be a neural network. For example, a deep neural network models such as a convolutional neural network (CNN), a Generative Adversarial Network (GAN), a feature space augmentation and Auto Encoder model, a Meta-Learning model, and so forth may be used.

FIG. 1B is a diagram illustrating an example network architecture 100B, in accordance with example embodiments. In some embodiments, each intermediate machine learning model of the plurality of intermediate machine learning models may be an encoder-decoder neural network with skip connections. In some embodiments, each encoder-decoder subnetwork may include three encoder stages and three decoder stages. In some embodiments, each encoder stage may include a feature extraction module and two nonlinear transformation modules. In some embodiments, each decoder stage may include two nonlinear transformation modules and a feature reconstruction module. In some embodiments, the given image may be processed at different scales, and an output of a given scale may be upsampled and concatenated with an input of a successive scale.

For example, DeepMode may be a multi-scale encoder-decoder network with skip connections. The network may process an input image 150 at different scales, where an output of a given scale is upsampled and concatenated with the input at the following scale. For example, the output scale N indicated as 170-N of the Nth scale is upsampled and concatenated with the input scale N−1 (not shown in the figure), the output scale N−1 (not shown in the figure) of the (N−1)th scale is upsampled and concatenated with the input scale N−2 (not shown in the figure), and so on, until the output scale 2 (not shown in the figure) of the 2^{nd} scale is upsampled and concatenated with the input scale 1 (indicated as 153-1).

At each scale, input image 150 may be resized to generate resized scale 1 labeled as 152-1, all the way to resized scale N labeled as 152-N. Also, at each scale, each encoder-decoder subnetwork may include three encoder stages (e.g., Enc 1 at scale 1, labeled as 156-1, to Enc 1 at scale N, labeled as 156-N; Enc 2 at scale 1, labeled as 158-1, to Enc 2 at scale N, labeled as 158-N; and Enc 3 at scale 1, labeled as 158-1, to Enc 3 at scale N, labeled as 158-N). In some embodiments, each encoder stage may include a feature extraction module and two nonlinear transformation modules, as indicated by legend 176.

Also, at each scale, each encoder-decoder subnetwork may include three decoder stages (e.g., Dec 1 at scale 1, labeled as 166-1, to Dec 1 at scale N, labeled as 166-N; Dec 2 at scale 1, labeled as 164-1, to Dec 2 at scale N, labeled as 164-N; and Dec 3 at scale 1, labeled as 162-1, to Dec 3 at scale N, labeled as 162-N). In some embodiments, each decoder stage may include a feature reconstruction module and two nonlinear transformation modules. In some embodiments, one or more of Dec 3 at scale 1, labeled as 162-1, to Dec 3 at scale N, labeled as 162-N, may include two nonlinear transformation modules, without the feature reconstruction module.

Also, for example, at each scale, the neural network may include one or more skip connections. For example, skip connection 172-1 may connect the last nonlinear transformation module of Enc 2 at scale 1, labeled as 158-1, with the respective first nonlinear transformation module of Dec 2 at scale 1, labeled as 164-1, and so on till skip connection 172-N connects the last nonlinear transformation module of Enc 2 at scale N, labeled as 158-N, with the respective first nonlinear transformation module of Dec 2 at scale N, labeled as 164-N.

Similarly, skip connection 174-1 may connect the last nonlinear transformation module of Enc 1 at scale 1, labeled as 156-1, with the respective first nonlinear transformation module of Dec 1 at scale 1, labeled as 166-1, and so on till skip connection 174-N connects the last nonlinear transformation module of Enc 1 at scale N, labeled as 156-N, with the respective first nonlinear transformation module of Dec 1 at scale N, labeled as 166-N.

In some embodiments, each encoder/decoder block may include a high-order residual convolutional block. The architecture enables significant improvements in computational efficiency, and reduces the memory footprint.

In some embodiments, each intermediate machine learning model may include one or more space-to-depth (s2d) layers. For example, s2d layers 154-1, . . . , 154-N may be included at each scale. Each s2d layer may enable low-resolution processing by taking an input, reducing a spatial resolution for the input while increasing a number of channels to preserve information. Also, for example, each intermediate machine learning model may include one or more depth-to-space (d2s) layers corresponding to the one or more s2d layers. For example, d2s layers 168-1, . . . , 168-N may be included at each scale. The s2d layers 154-1, . . . , 154-N, and the d2s layers 168-1, . . . , 168-N may be configured to accelerate the process and reduce memory usage. For example, DeepMode architecture 100B may be configured to include space-to-depth (depth-to-space) layers that take the input and rearrange as a tensor of smaller spatial resolution but with more channels (e.g., information is preserved). The core processing may be performed at a low-resolution (e.g., 2-4 times smaller than the original input resolution). Some embodiments may be configured without one or more of the s2d layers 154-1, . . . , 154-N, and the d2s layers 168-1, . . . , 168-N.

In some embodiments, upsample convolution layers may be implemented as transposed convolutions, and/or by performing bilinear upscaling followed by a regular convolution. Generally speaking, a bilinear upscaling followed by regular convolutions may reduce the total memory footprint and the amount of (grid) artifacts when the network is quantized to integer.

In some embodiments, the modules in the first encoder stage, (e.g., Enc 1 at scale 1, labeled as 156-1, to Enc 1 at scale N, labeled as 156-N) and the first decoder stage (e.g., Dec 1 at scale 1, labeled as 166-1, to Dec 1 at scale N, labeled as 166-N) may have filters of size 32.

In some embodiments, the modules in the second encoder stage (e.g., Enc 2 at scale 1, labeled as 158-1, to Enc 2 at scale N, labeled as 158-N) and the second decoder stage (e.g., Dec 2 at scale 1, labeled as 164-1, to Dec 2 at scale N, labeled as 164-N) may have filters of size 64.

In some embodiments, the modules in the third encoder stage (e.g., Enc 3 at scale 1, labeled as 158-1, to Enc 3 at scale N, labeled as 158-N) and the third decoder stage (e.g., Dec 3 at scale 1, labeled as 162-1, to Dec 3 at scale N, labeled as 162-N) may have filters of size 128.

In some embodiments, each encoder-decoder layer may be run through 3×3 convolutions followed by Leaky ReLU activations. In some embodiments, the encoder may utilize blur-pooling layers for down-sampling, whereas the decoder may utilize bilinear resizing followed by a 3×3 convolution for up-sampling.

In some embodiments, parameter sharing may be performed across the different scales. For example, with reference to an encoder stage, a scale recurrent structure may be used with the same parameters being shared across scales. For example, feature extraction modules at the first, second, and third encoder stages may share parameters across scales. Likewise, first nonlinear transformation modules at the first, second, and third encoder stages may share parameters across scales. Also, for example, second nonlinear transformation modules at the first, second, and third encoder stages may share parameters across scales.

In some embodiments, a modified scale recurrent structure may be used with independent feature extraction modules. In such an embodiment, like the scale recurrent structure, first nonlinear transformation modules at the first, second, and third encoder stages may share parameters across scales. Also, for example, second nonlinear transformation modules at the first, second, and third encoder stages may share parameters across scales.

In some embodiments, the modified scale recurrent structure may be further modified, where the feature extraction modules remain independent. However, both the first and the second nonlinear transformation modules may share parameters within a stage, and also across scales.

In some embodiments, each intermediate machine learning model of the plurality of intermediate machine learning models may be associated with a respective number of filters, and a respective space-to-depth parameter. Various base configurations spanning different model capacities and computational resources may be determined. For example, a light model may be configured comprising 4 space-to-depth parameters, 28 or 32 filters, and a residual convolutional block of order 5, abbreviated as s4-f [28,32]-r5. In some embodiments, the image transformation model (e.g., image transformation model 140) may be configured as a light model. As another example, a base model may be configured comprising 2 space-to-depth parameters, 16 filters, and a residual convolutional block of order 5, abbreviated as s2-f16-r5. Also, for example, a heavy model may be configured comprising 2 space-to-depth parameters, 32 filters, and a residual convolutional block of order 5, abbreviated as s2-f32-r5. In some embodiments, the plurality of intermediate machine learning models (e.g., plurality of intermediate machine learning models 125-1, 125-2, . . . , 125-N) may be configured as a heavy model.

In some embodiments, there may be a gain from using a “swish” or “hardswish” activation function as opposed to a “ReLu” or “ReLu6” activation function.

Table 1 illustrates basic performance information for different DeepMode configurations, for example, for a float32 model.

TABLE 1

| | Flops | Peak Memory | |
|---|---|---|---|
| | (input | (input | Number |
| Model | 1024 × 1024 × 3) | 1024 × 1024 × 3) | Parameters |
| s4-f28-r5 | 85.35b flops | 934.43 MB | 3.50 m |
| no-transposed- | | | |
| convolution | | | |
| s4-f32-r5 | 110.43b flops | 1058.27 MB | 4.55 m |
| no-transposed- | | | |
| convolution | | | |
| s2-f16-r5 | 107.08b flops | 1953.54 MB | 1.12 m |
| no-transposed- | | | |
| convolution | | | |
| s2-f32-r5 | 420.28b flops | 3791.14 MB | 4.46 m |
| no-transposed- | | | |
| convolution | | | |

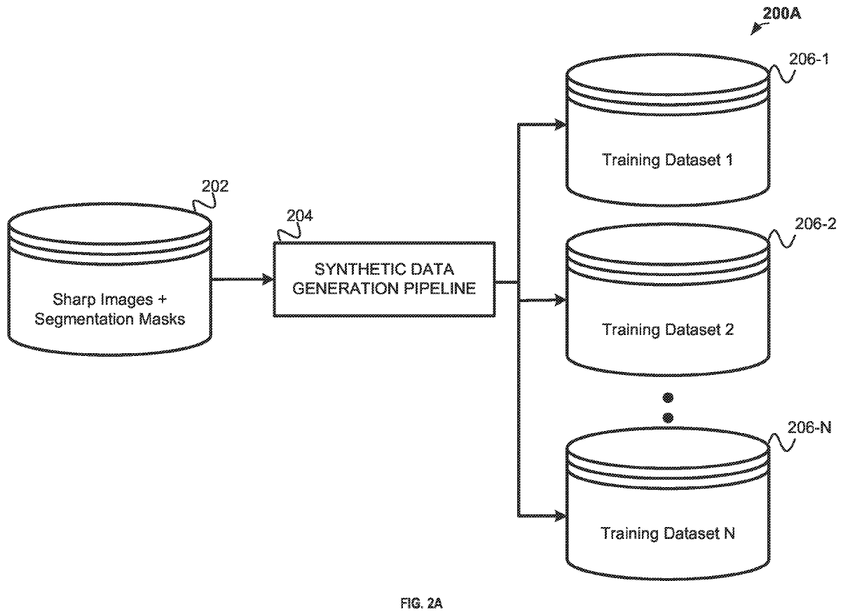

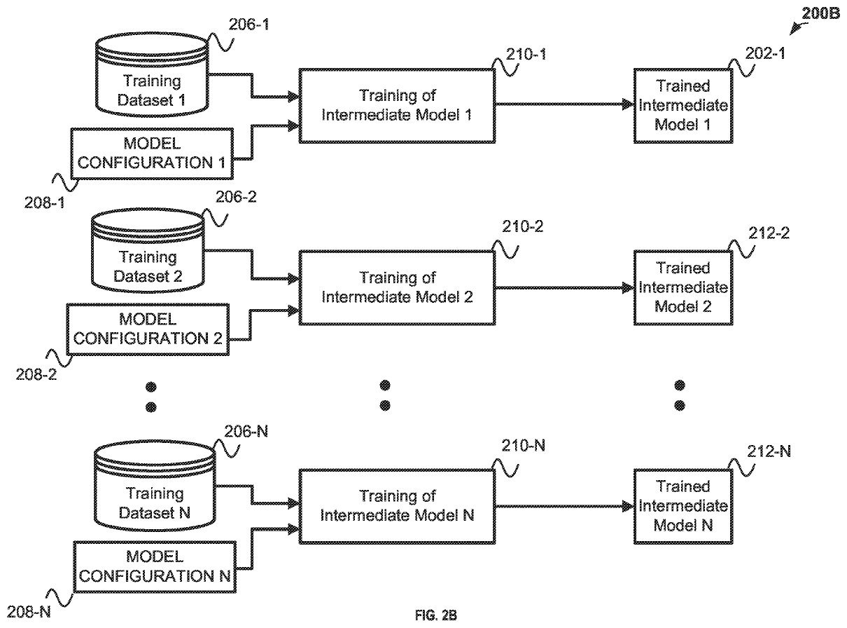

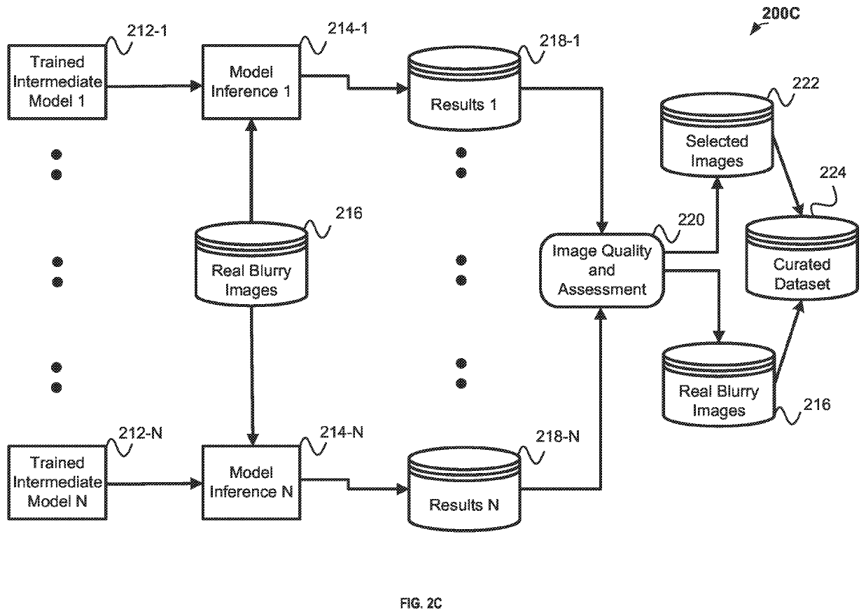

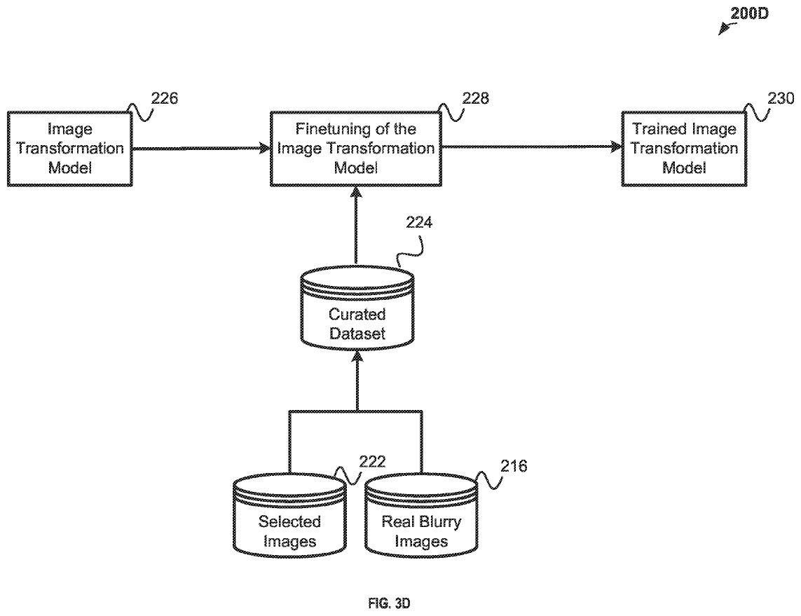

FIGS. 2A-D illustrates a training pipeline. The training may proceed in two steps: first, different DeepMode models may be trained, and then fine-tuned on a curated dataset of carefully selected real images.

FIG. 2A is a diagram illustrating an example overview of a pipeline 200A to generate synthetic data, in accordance with example embodiments. For example, based on a database 202 including a plurality of sharp images and segmentation masks, different training datasets, training dataset 1 denoted as 206-1, training dataset 2 denoted as 206-2, and so on till training dataset N, 206-N, may be generated using different configurations in the synthetic data generation pipeline 204.

Some embodiments involve training a plurality of intermediate machine learning models to remove the one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors.

FIG. 2B is a diagram illustrating an example training 200B of multiple intermediate models, in accordance with example embodiments. For example, N different DeepModels, such having different configurations (e.g., number of filters, the space-to-depth parameter, and so forth) may be trained. For example, training of model 1 denoted 210-1 may be performed on training dataset 1 denoted as 206-1 and model configuration 1 denoted as 208-1, to generate trained intermediate model 1 denoted 212-1. As another example, training of model 2 denoted 210-2 may be performed on training dataset 2 denoted as 206-2 and model configuration 2 denoted as 208-2, to generate trained intermediate model 2 denoted 212-2. Also, for example, training of model N denoted 210-N may be performed on training dataset N denoted as 206-N and model configuration N denoted as 208-N, to generate trained intermediate model N denoted 212-N. In some embodiments, trained intermediate model 1 denoted 212-1, trained intermediate model 2 denoted 212-2, . . . , trained intermediate model N denoted 212-N, may serve as teachers to distill and/or finetune a student model on a dataset of real images (having real degradations not simulated with the data generation pipeline).

Some embodiments involve applying the plurality of trained intermediate machine learning models to a given real image of the additional training dataset of real images to generate corresponding output images. Such embodiments involve selecting, from the generated output images, an optimally transformed version of the given real image. Such embodiments also involve generating a curated dataset comprising pairs of real images and corresponding optimally transformed versions of the real images. In some embodiments, the application of the plurality of trained intermediate machine learning models to the given real image involves applying each trained intermediate machine learning model at multiple resolutions.

FIG. 2C is a diagram illustrating an example pipeline 200C to generate a curated dataset, in accordance with example embodiments. In some embodiments, a database of real blurry images 216 may be used. For example, a database of real blurry images 216 may include approximately 500 images having real degradations (e.g., motion blur, lens blur, noise, compression artifacts, and so forth). There may not be high-quality counterparts corresponding to these images. In some embodiments, the plurality of trained intermediate machine learning models may be applied to a given real image of the additional training dataset of real images (e.g., from the database of real blurry images 216) to generate a corresponding output image. For example, the trained intermediate model 1 denoted 212-1, trained intermediate model 2 denoted 212-2, . . . , trained intermediate model N denoted 212-N, may be run at multiple resolutions, for example as teacher models. For example, model inference 1 denoted 214-1 may be performed using the database of real blurry images 216 with the trained intermediate model 1 denoted 212-1 to generate predicted results 1 denoted as 218-1. Likewise, model inference N denoted 214-N may be performed using the database of real blurry images 216 with the trained intermediate model N denoted 212-N to generate predicted results N denoted as 218-N.

In some embodiments, the method may involve selecting, from the generated output images, an optimally transformed version of the given real image. For example, such an operation may include performing a downscale operation, running the respective intermediate machine learning model, and performing an upscale operation to achieve a target resolution. In some embodiments, for each image in the database of real blurry images 216, an image quality and assessment 220 may be performed on all the corresponding results output by the respective trained intermediate models, and a best output may be selected from among the results. Accordingly, each input image from the database of real blurry images 216 may be associated with a best output. For example, each low-quality input image in the database of real blurry images 216 may be associated with a restored image that is generated with one of the trained deep intermediate models. In some embodiments, the image quality and assessment 220 may be performed using neural image assessment (NIMA) scores and/or by manual selection.

This process generates a paired curated (or Golden Standard) dataset 224 of real degraded images (e.g., from the database of real blurry images 216), and their high-quality restored counterpart (e.g., the output of the image quality and assessment 220) stored in the database of selected images 222. Accordingly, curated dataset 224 includes pairs such as “(real image, selected image)”.

FIG. 2D is a diagram illustrating an example training 200D of an image transformation model, in accordance with example embodiments. As described herein, curated dataset 224 may be generated based on the database of real blurry images 216, and the database of selected images 222. In some embodiments, the training of the image transformation model involves fine-tuning the image transformation model based on the curated dataset. A fine-tuning 228 of the image transformation model 226 (for example, a model that has a desired latency, memory usage, and so forth) may be performed based on the curated dataset 224.

In such embodiments, the fine-tuning 228 of the image transformation model 226 may involve Quantized Aware Training (QAT). Also, for example, trained image transformation model 230 may be generated, and exported as, for example, a TensorFlow Lite integer model, if needed.

In some embodiments, each base DeepMode model may be trained using an adaptive moment estimation (ADAM) optimizer with default parameters. In some embodiments, the learning rate may be set to 1e-4, and a polynomial decay (e.g., factor=1.0) may be applied. Also, for example, in some embodiments, a complete optimization process may be run for 1.5M iterations. In some embodiments, a mini-batch size of 8 may be used.

In some embodiments, the model may be trained using a L₁ loss function to penalize pixel value difference at the multiple output scales. Also, for example, a penalization on the difference between the gradients of target and reconstruction may be applied. As another example, a penalizing L₁ norm of the gradient difference may be applied. Additional, and/or alternative sophisticated loss functions, such as a polarization dependent loss (PDL), may be applied.

In some embodiments, training the same model multiple times in the same way, but with a different random initialization, may produce different results on real data. This may be despite trained models reaching a similar accuracy on the training and/or evaluation data (that is the data from the synthetic data generation pipeline). Accordingly, it may be desirable to train and fine-tune on real images.

### Training Data

Generally, it may be challenging to obtain ground-truth degraded-sharp paired data for use in supervised blind deblurring (and in general in image restoration). For example, a complicated setup may be needed to acquire paired photographs with, for example, different exposition times, different camera configurations, and so forth.

Some existing techniques enabling synthesis of motion blur (e.g., due to camera or object) may be performed based on two procedures. For example, a (virtually) longer exposure time may be emulated leading to a natural appearance of blur in images. This may be performed by capturing high-frame-rate videos, and then averaging a window of consecutive frames, where the larger of the temporal window controls an increase of the exposure (and therefore leads to more blur in the capture). However, such a technique has certain limitations. For example, to accurately simulate a longer exposure, frames need to be captured for all the inter-frame time (e.g., the camera is always capturing light in a continuous way). However, this is not the case in practice. Therefore, a direct average of consecutive frames may lead to ghosting-type of artifacts when the motion is larger than a pixel. To avoid this issue, a typical solution may be to interpolate multiple in-between frames before computing a temporal average. Unfortunately this may involve solving a technically challenging problem of frame temporal interpolation.

A different procedure may be to simulate motion blur and other degradations on high-quality images. Such an approach may be challenging since different objects, and/or different parts of a scene, may undergo different motions, and may therefore result in different blur. Also, for example, camera-shake may lead to blur that is not shift invariant.

Accordingly, as described below, multiple degradations may be synthetically generated on reference high-quality frames.

### Data Generation Pipeline

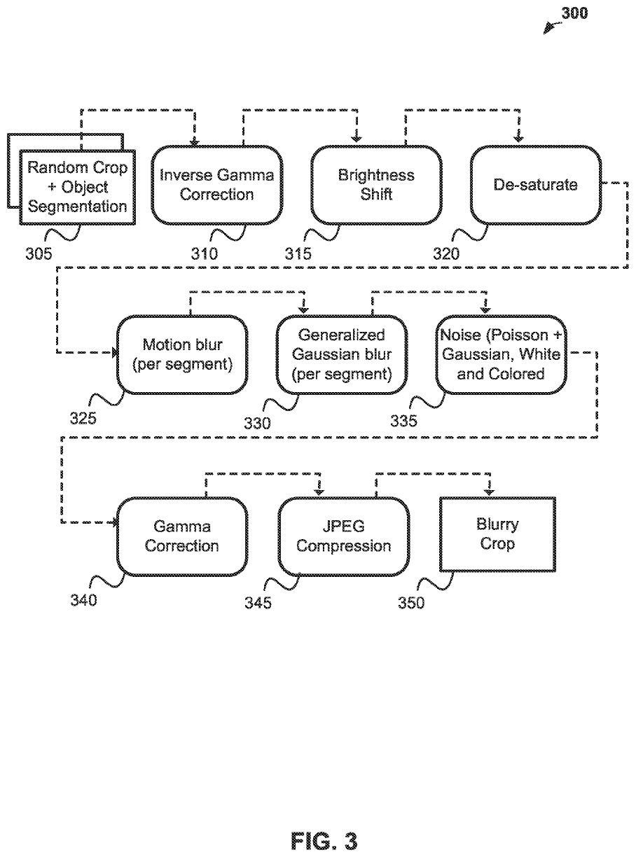

FIG. 3 is a diagram illustrating an example pipeline 300 to generate synthetic data, in accordance with example embodiments. In some embodiments, a random crop and an associated random segmentation (e.g., binary mask) of an image may be generated, as illustrated at block 305. Then, a gamma correction value may be sampled, and the corresponding inverse gamma correction 310 may be applied. A brightness shift 315 may be applied by randomly shifting pixel values by a constant factor (e.g., for data augmentation). Subsequently, saturated, or almost or nearly saturated pixels may be randomly extrapolated to desaturate 320. Motion blur 325 and Generalized Gaussian blur 330 may be simulated. For example, these operations may be performed per segment or for a complete crop. Also, for example, noise 335 (e.g., Poisson, Gaussian, white, colored, and so forth), may be added, and gamma correction 340 may be applied. In some embodiments, a JPEG compression 345 (e.g., with a random quality factor sampled from a predefined distribution) may be applied to the blurry image to generate a blurry crop 350.

### Random Motion Blur Kernels

In some embodiments, the plurality of degradation factors may include a motion blur. Such embodiments involve generating one or more motion kernels that simulate camera-shake due to hand-tremor, wherein an amount of the motion blur is associated with a scale parameter related to exposure time. For example, motion kernels may be simulated by mimicking camera-shake due to hand-tremor. An amount of blur (e.g., expected value) may be controlled by a parameter related to an exposure time, referred to herein as “scale”. In some embodiments, motion kernels may be generated from discretized two-dimensional (2D) random walks. For example, to synthesize a motion kernel, a small Gaussian kernel (e.g., with standard deviation=0.35) may be rendered and accumulated at each discrete location of the random walk. In some embodiments, the kernels may be non-negative by construction, and may be normalized to have area one (e.g., light conservation).

In some embodiments, the strength of the blur may be controlled by the random walk properties. To render kernels that are generally smooth, but that may also lead to certain changes the following procedure may be applied:

Let N be the length of the random walk. Then, 2×N independent and identically distributed Gaussian variables may be sampled from a normal distribution, N(0,Id), resulting in the horizontal and vertical components of the random walk. Such random variables are generally representative of an acceleration at each discrete time step.

In some embodiments, the 2×N vector may be integrated twice along each dimension (‘cumsum’) to generate a sufficiently smooth enough random walk.

In some embodiments, to represent different strengths of the blur, values in the random walk vector may be multiplied by a factor (scale/N). Generally, a larger factor corresponds to a larger motion. In some embodiments, this factor may be a random value sampled from a Gamma distribution.

In some embodiments, to avoid transitory issues, a first half of the random walk may be removed. Also, for example, the reminder may be centered by subtracting an average of each dimension. Accordingly, a kernel having a centered first moment may be generated (i.e., the motion kernel does not shift the image).

In some embodiments, the random kernel may be generated by rasterizing the random walk as mentioned above.

In practice, fixing N to a large value (e.g., N=300), and controlling a single parameter ‘scale’ may result in a practical way of simulating blurs of different intensities, while keeping the number of tunable parameters to a minimum.

The support of the kernel may be chosen to be large enough to include the entire kernel. In some embodiments, the kernel may be subsequently trimmed to a minimum containing support to accelerate a filtering process.

### Approximated Kernel Length (Motion Blur Strength)

The kernel length may be computed as an inverse of the L₂ norm of the kernel. The motivation for this may be that for a complete uniform-motion kernel of length L,

$${‖ k ‖}^{2} = {\sum }_{i} {k}_{i}^{2} = {L ( 1 / L )}^{2} = 1 / L \qquad ( Eqn . 2 )$$

In some embodiments, the L₂ norm of the kernel measures the spread of a non-negative blurring kernel:

$$0 < {‖ k ‖}_{2}^{2} = \sum {k}_{i}^{2} \leq {\sum }_{i} {k}_{i} = 1 \qquad ( Eqn . 3 )$$

The limit case, L₂ (k)=1 occurs when the kernel is a Delta (sharpest), and as the kernel gets larger, L₂ (k)→0.

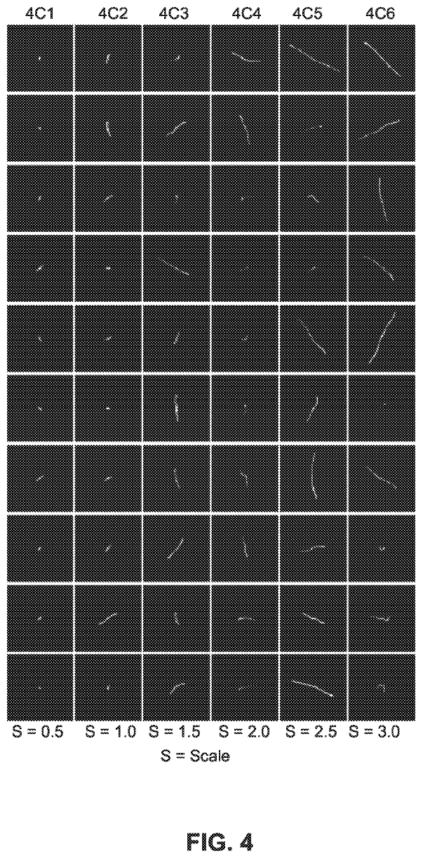

FIG. 4 illustrates example motion blur kernels for different scale parameters, in accordance with example embodiments. For example, images in column 4C1 correspond to a scale parameter, s=0.5, images in column 4C2 correspond to a scale parameter, s=1.0, images in column 4C3 correspond to a scale parameter, s=1.5, images in column 4C4 correspond to a scale parameter, s=2.0, images in column 4C5 correspond to a scale parameter, s=2.5, and images in column 4C6 correspond to a scale parameter, s=3.0.

In Table 2, statistics of the generated kernels as a function of a “scale” parameter are summarized for different motion levels. In some embodiments, the results may be generated with approximately 1000 sampled kernels per scale.

TABLE 2

| | Mean | Median | Max | Std |
|---|---|---|---|---|
| Scale | (length) | (length) | (length) | (length) |
| 0.5 | 6.38 | 6.00 | 18.84 | 3.12 |
| 1.0 | 12.35 | 11.47 | 36.69 | 6.17 |
| 1.5 | 18.09 | 16.96 | 57.26 | 9.02 |
| 2.0 | 23.82 | 22.53 | 77.27 | 12.02 |
| 2.5 | 29.57 | 27.88 | 86.24 | 14.80 |
| 3.0 | 35.07 | 32.43 | 99.47 | 18.00 |

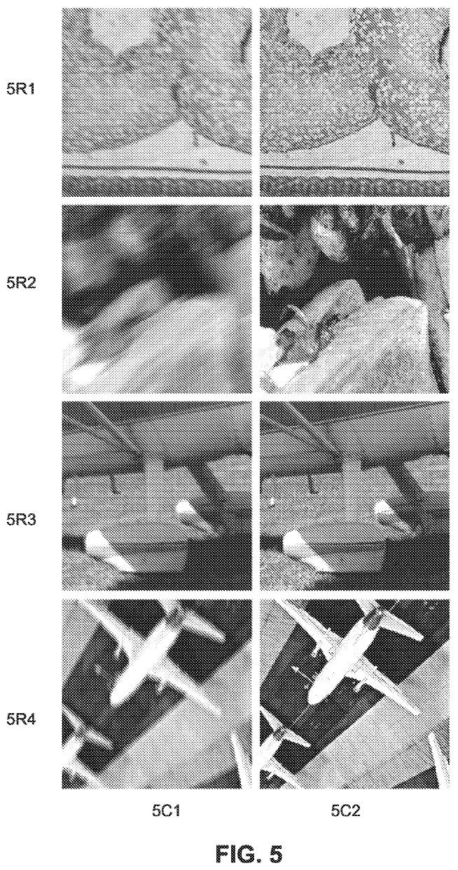

FIG. 5 illustrates example input and output images corresponding to a simulated motion blur, in accordance with example embodiments. For example, images in column 5C1 correspond to sharp images in column 5C2, modified by a simulated motion blur, as described herein. For example, the image of a pretzel in row 5R1 and column 5C1 corresponds to a synthetically blurred version of a corresponding image in row 5R1 and column 5C2.

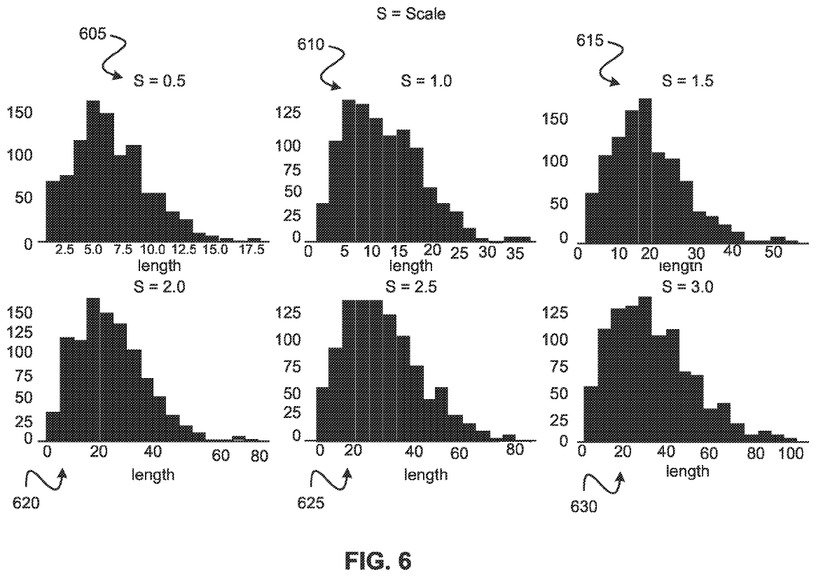

FIG. 6 illustrates example histograms relating motion kernel length as a function of a scale parameter, in accordance with example embodiments. The illustrated histograms may, in some embodiments, be based on results generated with approximately 1000 sampled kernels per scale. The distribution of the (approximate) length of generated kernels for different “scale” parameters may be a known quantity. In some embodiments, the distribution of generated motion blur kernels may be significant in the learning process to deblur the images. The generated distribution may include images with different levels of blur (e.g., sharp, moderate blurry and very blurry, and so forth) in order that the network understands the deblurring problem. As illustrated, histogram 605 corresponds to a scale parameter, s=0.5, histogram 610 corresponds to a scale parameter, s=1.0, histogram 615 corresponds to a scale parameter, s=1.5, histogram 620 corresponds to a scale parameter, s=2.0, histogram 625 corresponds to a scale parameter, s=2.5, and histogram 630 corresponds to a scale parameter, s=3.0.

### Generalized Gaussian Blur

In some embodiments, the plurality of degradation factors may include a lens blur. Such embodiments involve generating one or more generalized Gaussian blur kernels that simulate the lens blur. The generalized Gaussian blur may be used to simulate lens blur, and/or a mild out-of-focus effect. In some embodiments, a parametric generalized Gaussian blur kernel may be used. A shape and size of the parametric generalized Gaussian blur kernel may be controlled by four parameters: σ₀, ρ, θ, γ.

$$k ( x , y ; [ a , b , c , d , γ ] ) = Z exp ( - {( {ax}^{2} + 2 bxy + {cy}^{2} )}^{γ} ) \qquad ( Eqn . 4 )$$

$$where ,$$

$$a = \frac{{cos}^{2} ( θ )}{2 {σ}_{0}^{2}} + \frac{{sin}^{2} ( θ )}{2 {ρ}^{2} {σ}_{0}^{2}} , b = \frac{sin ( 2 θ )}{4 {σ}_{0}^{2}} ( \frac{1}{{ρ}^{2}} - 1 ) , c = \frac{{sin}^{2} ( θ )}{2 {σ}_{0}^{2}} + \frac{{cos}^{2} ( θ )}{2 {ρ}^{2} {σ}_{0}^{2}} \qquad ( Eqn . 5 )$$

As described, this may be a rather general model for mild lens blur. However, this may not capture bokeh effects due to different cameras, since the kernels for such bokeh effects correspond to donut shaped kernels.

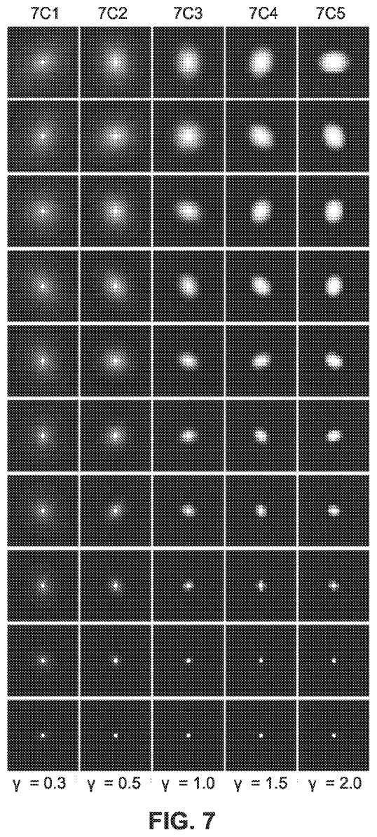

FIG. 7 illustrates example generalized Gaussian blur kernels, in accordance with example embodiments. The generalized Gaussian kernels illustrated in the different columns correspond to different values of gamma. For example, kernels in column 7C1 correspond to a gamma value of γ=0.3, kernels in column 7C2 correspond to a gamma value of γ=0.5, kernels in column 7C3 correspond to a gamma value of γ=1.0, kernels in column 7C4 correspond to a gamma value of γ=1.5, and kernels in column 7C5 correspond to a gamma value of γ=2.0. Also illustrated is a random orientation (theta, θ), and a non-unitarian eccentricity (rho, φ, and an increasing size from left to right across each row.

### Image Noise/JPEG Compression Artifacts

In some embodiments, the plurality of degradation factors include one or more of additive noise, signal dependent noise, or colored noise. Image noise on an RGB space may be significantly complex, as it may be signal dependent and correlated (e.g., colored). Also, for example, a fingerprint of the noise may significantly depend on a camera sensor, and/or camera ISP, and other post processing (e.g., denoising, sharpening, resizing, and so forth).

Generally, DeepMode may be configured to transform arbitrary images. Accordingly, a general noise model may be simulated for training purposes.

In some embodiments, additive and signal dependent noise may be simulated that can mimic read out and shot noise.

In some embodiments, colored (e.g., correlated) noise may be simulated by filtering the noise layer with a Gaussian blur kernel of random standard deviation, and by adding it back to the noise layer (e.g., after multiplication by a random factor).

In some embodiments, the plurality of degradation factors include one or more image compression artifacts. In general, shared images may be compressed with JPEG compression. There are several ways to implement the JPEG standard. In particular, the JPEG quality factor may affect quantization of discrete cosine transform (DCT) coefficients, and/or may impact the way chroma subsampling is performed. Accordingly, in the synthetic data generation pipeline, greater control of the image generation may be achieved without performing chroma subsampling when a quality factor equal to, or greater than, 90 is used. Alternatively, a standard 420 subsampling may be adopted.

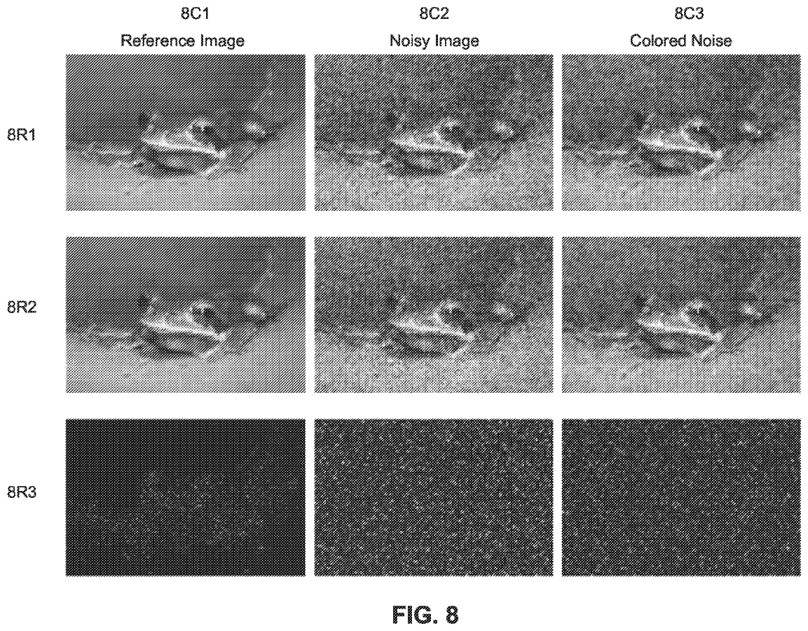

FIG. 8 illustrates example input and output images corresponding to simulated compression artifacts, in accordance with example embodiments. JPEG compression may affect the image by introducing artifacts, but JPEG compression may also introduce correlations in the noise. Reference images are shown in column 8C1, noisy images are shown in column 8C2, and images with colored noise are shown in column 8C3. The last row 8R3 shows a difference (amplified by a factor of 5) of the first row 8R1 and the second row 8R2.

The synthetic data generation pipeline may be configured to enable the compression of blurry images using a random quality factor sampled from a uniform distribution, where the two extremes are configurable parameters. Also, JPEG compression may introduce a perturbation on the adopted noise distribution.

### Desaturation

In some embodiments, the plurality of degradation factors include one or more artifacts caused by saturated pixels. Saturated pixels are problematic since the blur effect may overspill to adjacent pixels. However, a reference frame with saturated pixels does not provide an indication of the actual radiance of a saturated pixel in the reference frame. Some embodiments involve determining whether a pixel value exceeds a saturation threshold. For example, a saturation threshold may be determined. Such embodiments also involve, based on a determination that the pixel value exceeds the saturation threshold, multiplying the pixel value by a random factor. Pixel values that are above the threshold may be multiplied by a random factor (sampled from a predetermined uniform interval).

Accordingly, when blur is applied to a sharp desaturated image, that may be later clipped to mimic sensor saturation, a saturated pixel contributes more than the saturated value, leading to a more realistic blur simulation.

Generally, it may be desirable to use the saturation threshold conservatively (e.g., not too far from the max value (i.e., 1.0 or 255)). In situations where the margin is large, the simulated training data may generate a model where saturated areas become thinner.

In some embodiments, to synthetically generate degraded-sharp image pairs, images from a database, such as, the Open Images Dataset (OID) may be used. To use high-quality images as input, images may be filtered out based on blurriness, and NIMA scores. Images from the OID include object segmentation that may be used to render different blurs to different segments. To simplify the synthetic data generation pipeline, images from OID, such as .jpg and/or .png files may be directly used with their respective segmentation masks.

In some embodiments, approximately 7000 images from the OID dataset having a NIMA score larger than or equal to 7, and a Polysharp blurriness score smaller than 0.65, may be used. Semantic-aware sampling may not need to be performed.

A large number of (visually) different training datasets may be designed and evaluated, spanning different compromises between blur strength, noise distribution, among many other parameters. The visual quality of the results depends on the capacity of the model. Since the training dataset is synthetically generated, different models having different capacities may produce the optimal results with different training datasets.

### Results

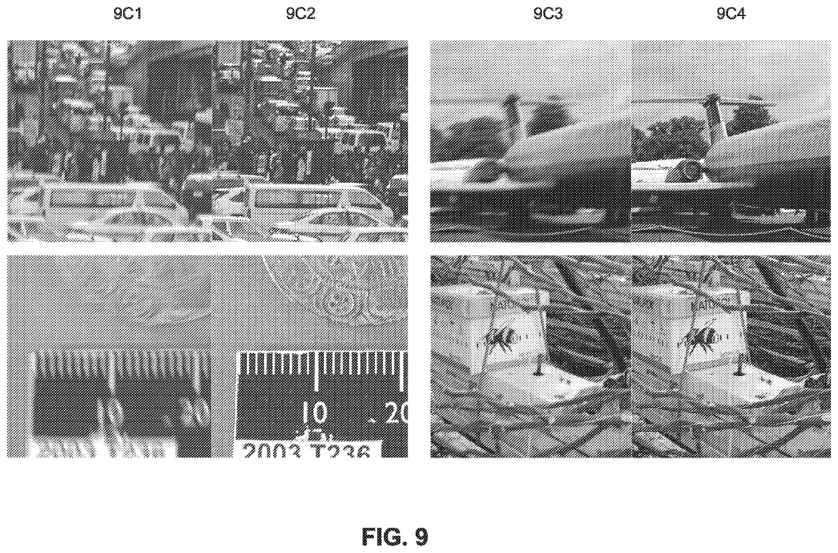

FIG. 9 illustrates example images corresponding to training data generation, in accordance with example embodiments. Images in column 9C1 are the synthetically degraded versions of the images in column 9C2. Similarly, images in column 9C3 are the synthetically degraded versions of the images in column 9C4.

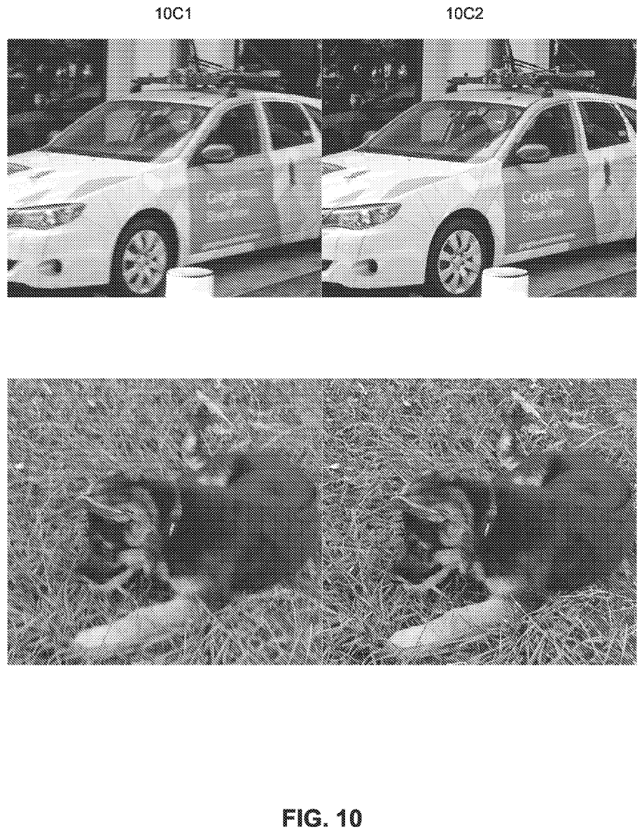

FIG. 10 illustrates example output images of a trained image transformation model, in accordance with example embodiments. Images in column 10C2 are the transformed (predicted) versions of the images in column 10C1 that are input into the trained image transformation model described herein.

As described herein, DeepMode is an end-to-end solution to remove image degradations such as blur, noise, compression artifacts, and so forth, in images trained with pairs of synthetically generated, degraded images and clean, sharp image.

### Training Machine Learning Models for Generating Inferences/Predictions

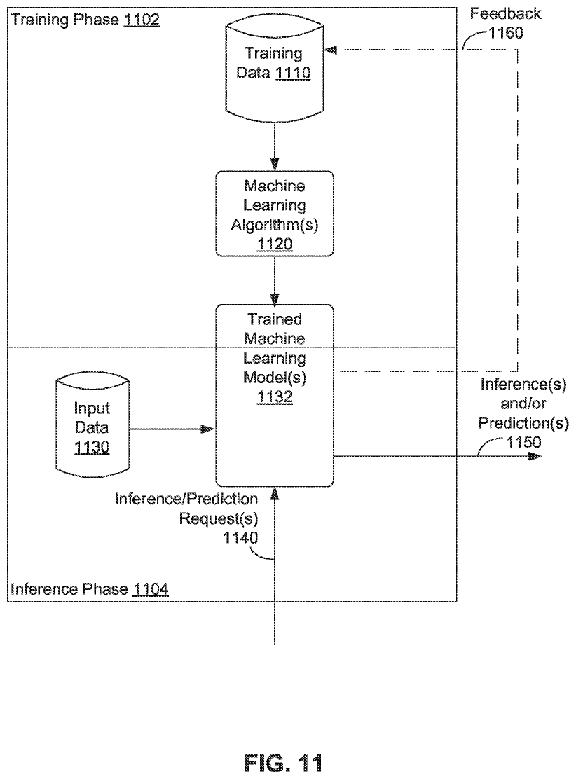

FIG. 11 shows diagram 1100 illustrating a training phase 1102 and an inference phase 1104 of trained machine learning model(s) 1132, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 11 shows training phase 1102 where one or more machine learning algorithms 1120 are being trained on training data 1110 to become trained machine learning model(s) 1132. Then, during inference phase 1104, trained machine learning model(s) 1132 can receive input data 1130 and one or more inference/prediction requests 1140 (perhaps as part of input data 1130) and responsively provide as an output one or more inferences and/or prediction(s) 1150.

As such, trained machine learning model(s) 1132 can include one or more models of one or more machine learning algorithms 1120. Machine learning algorithm(s) 1120 may include, but are not limited to: an artificial neural network (e.g., herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 1120 may be supervised or unsupervised, and may implement any suitable combination of online and offline learning.

In some examples, machine learning algorithm(s) 1120 and/or trained machine learning model(s) 1132 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 1120 and/or trained machine learning model(s) 1132. In some examples, trained machine learning model(s) 1132 can be trained, can reside on, and be executed to provide inferences on a particular computing device, and/or otherwise can make inferences for the particular computing device.

During training phase 1102, machine learning algorithm(s) 1120 can be trained by providing at least training data 1110 as training input using unsupervised, supervised, semi-supervised, and/or reinforcement learning techniques. Unsupervised learning involves providing a portion (or all) of training data 1110 to machine learning algorithm(s) 1120 and machine learning algorithm(s) 1120 determining one or more output inferences based on the provided portion (or all) of training data 1110. Supervised learning involves providing a portion of training data 1110 to machine learning algorithm(s) 1120, with machine learning algorithm(s) 1120 determining one or more output inferences based on the provided portion of training data 1110, and the output inference(s) are either accepted or corrected based on correct results associated with training data 1110. In some examples, supervised learning of machine learning algorithm(s) 1120 can be governed by a set of rules and/or a set of labels for the training input, and the set of rules and/or set of labels may be used to correct inferences of machine learning algorithm(s) 1120.

Semi-supervised learning involves having correct results for part, but not all, of training data 1110. During semi-supervised learning, supervised learning is used for a portion of training data 1110 having correct results, and unsupervised learning is used for a portion of training data 1110 not having correct results. Reinforcement learning involves machine learning algorithm(s) 1120 receiving a reward signal regarding a prior inference, where the reward signal can be a numerical value. During reinforcement learning, machine learning algorithm(s) 1120 can output an inference and receive a reward signal in response, where machine learning algorithm(s) 1120 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 1120 and/or trained machine learning model(s) 1132 can be trained using other machine learning techniques, including but not limited to, incremental learning and curriculum learning.

In some examples, machine learning algorithm(s) 1120 and/or trained machine learning model(s) 1132 can use transfer learning techniques. For example, transfer learning techniques can involve trained machine learning model(s) 1132 being pre-trained on one set of data and additionally trained using training data 1110. More particularly, machine learning algorithm(s) 1120 can be pre-trained on data from one or more computing devices and a resulting trained machine learning model provided to computing device CD1, where CD1 is intended to execute the trained machine learning model during inference phase 1104. Then, during training phase 1102, the pre-trained machine learning model can be additionally trained using training data 1110, where training data 1110 can be derived from kernel and non-kernel data of computing device CD1. This further training of the machine learning algorithm(s) 1120 and/or the pre-trained machine learning model using training data 1110 of CD1's data can be performed using either supervised or unsupervised learning. Once machine learning algorithm(s) 1120 and/or the pre-trained machine learning model has been trained on at least training data 1110, training phase 1102 can be completed. The trained resulting machine learning model can be utilized as at least one of trained machine learning model(s) 1132.

In particular, once training phase 1102 has been completed, trained machine learning model(s) 1132 can be provided to a computing device, if not already on the computing device. Inference phase 1104 can begin after trained machine learning model(s) 1132 are provided to computing device CD1.

During inference phase 1104, trained machine learning model(s) 1132 can receive input data 1130 and generate and output one or more corresponding inferences and/or prediction(s) 1150 about input data 1130. As such, input data 1130 can be used as an input to trained machine learning model(s) 1132 for providing corresponding inference(s) and/or prediction(s) 1150 to kernel components and non-kernel components. For example, trained machine learning model(s) 1132 can generate inference(s) and/or prediction(s) 1150 in response to one or more inference/prediction requests 1140. In some examples, trained machine learning model(s) 1132 can be executed by a portion of other software. For example, trained machine learning model(s) 1132 can be executed by an inference or prediction daemon to be readily available to provide inferences and/or predictions upon request. Input data 1130 can include data from computing device CD1 executing trained machine learning model(s) 1132 and/or input data from one or more computing devices other than CD1.

Input data 1130 can include training data described herein, such as real blurry images, synthetically generated images, images in the curated dataset, and so forth. Other types of input data are possible as well. For example, training data may include the data collected to train the image transformation model.

Inference(s) and/or prediction(s) 1150 can include task outputs, numerical values, and/or other output data produced by trained machine learning model(s) 1132 operating on input data 1130 (and training data 1110). In some examples, trained machine learning model(s) 1132 can use output inference(s) and/or prediction(s) 1150 as input feedback 1160. Trained machine learning model(s) 1132 can also rely on past inferences as inputs for generating new inferences.

After training, the trained version of the neural network can be an example of trained machine learning model(s) 1132. In this approach, an example of the one or more inference/prediction request(s) 1140 can be a request to predict a transformed (e.g., deblurred, denoised, etc.) image and a corresponding example of inferences and/or prediction(s) 1150 can be a predicted transformed (e.g., deblurred, denoised, etc.) image.

In some examples, one computing device CD_SOLO can include the trained version of the neural network, perhaps after training. Then, computing device CD_SOLO can receive a request to transform (e.g., deblurred, denoised, etc.) an image, and use the trained version of the neural network to predict the transformed (e.g., deblurred, denoised, etc.) image.

In some examples, two or more computing devices CD_CLI and CD_SRV can be used to provide output; e.g., a first computing device CD_CLI can generate a request to predict a transformed (e.g., deblurred, denoised, etc.) image to a second computing device CD_SRV. Then, CD_SRV can use the trained version of the neural network, to predict the transformed (e.g., deblurred, denoised, etc.) image, and respond to the requests from CD_CLI. Then, upon reception of responses to the requests, CD_CLI can provide the requested output (e.g., using a user interface and/or a display, a printed copy, an electronic communication, etc.).

### Example Data Network

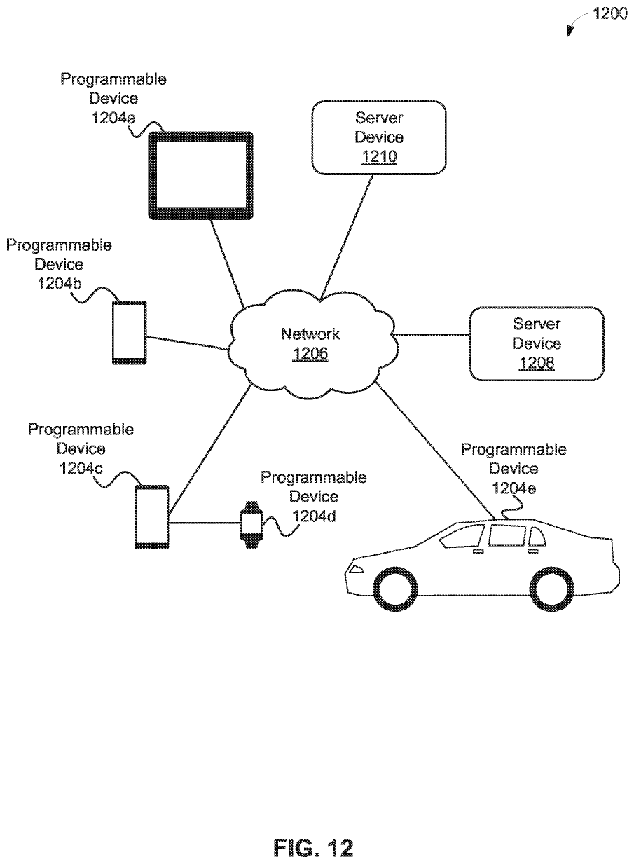

FIG. 12 depicts a distributed computing architecture 1200, in accordance with example embodiments. Distributed computing architecture 1200 includes server devices 1208, 1210 that are configured to communicate, via network 1206, with programmable devices 1204a, 1204b, 1204c, 1204d, 1204e. Network 1206 may correspond to a local area network (LAN), a wide area network (WAN), a WLAN, a WWAN, a corporate intranet, the public Internet, or any other type of network configured to provide a communications path between networked computing devices. Network 1206 may also correspond to a combination of one or more LANs, WANs, corporate intranets, and/or the public Internet.

Although FIG. 12 only shows five programmable devices, distributed application architectures may serve tens, hundreds, or thousands of programmable devices. Moreover, programmable devices 1204a, 1204b, 1204c, 1204d, 1204e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 1204a, 1204b, 1204c, 1204e, programmable devices can be directly connected to network 1206. In other examples, such as illustrated by programmable device 1204d, programmable devices can be indirectly connected to network 1206 via an associated computing device, such as programmable device 1204c. In this example, programmable device 1204c can act as an associated computing device to pass electronic communications between programmable device 1204d and network 1206. In other examples, such as illustrated by programmable device 1204e, a computing device can be part of and/or inside a vehicle, such as a car, a truck, a bus, a boat or ship, an airplane, etc. In other examples not shown in FIG. 12, a programmable device can be both directly and indirectly connected to network 1206.

Server devices 1208, 1210 can be configured to perform one or more services, as requested by programmable devices 1204a-1204e. For example, server device 1208 and/or 1210 can provide content to programmable devices 1204a-1204e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 1208 and/or 1210 can provide programmable devices 1204a-1204e with access to software for database, search, computation, graphical, audio, video, World Wide Web/Internet utilization, and/or other functions. Many other examples of server devices are possible as well.

### Computing Device Architecture

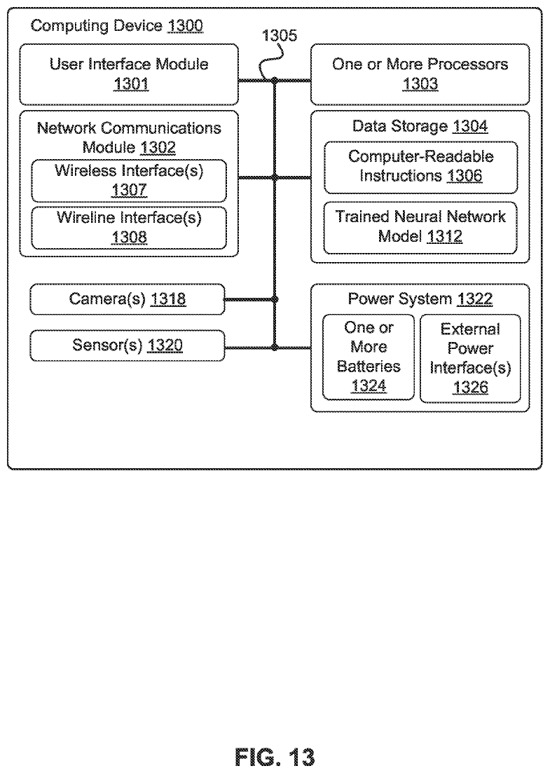

FIG. 13 is a block diagram of an example computing device 1300, in accordance with example embodiments. In particular, computing device 1300 shown in FIG. 13 can be configured to perform at least one function of and/or related to the neural networks described herein, and/or methods 1500, 1600.

Computing device 1300 may include a user interface module 1301, a network communications module 1302, one or more processors 1303, data storage 1304, one or more camera(s) 1318, one or more sensors 1320, and power system 1322, all of which may be linked together via a system bus, network, or other connection mechanism 1305.

User interface module 1301 can be operable to send data to and/or receive data from external user input/output devices. For example, user interface module 1301 can be configured to send and/or receive data to and/or from user input devices such as a touch screen, a computer mouse, a keyboard, a keypad, a touch pad, a trackball, a joystick, a voice recognition module, and/or other similar devices. User interface module 1301 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1301 can also be configured to generate audible outputs, with devices such as a speaker, speaker jack, audio output port, audio output device, earphones, and/or other similar devices. User interface module 1301 can further be configured with one or more haptic devices that can generate haptic outputs, such as vibrations and/or other outputs detectable by touch and/or physical contact with computing device 1300. In some examples, user interface module 1301 can be used to provide a graphical user interface (GUI) for utilizing computing device 1300, such as, for example, a graphical user interface of a mobile phone device.

Network communications module 1302 can include one or more devices that provide one or more wireless interface(s) 1307 and/or one or more wireline interface(s) 1308 that are configurable to communicate via a network. Wireless interface(s) 1307 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1308 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1302 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1303 can include one or more general purpose processors, and/or one or more special purpose processors (e.g., digital signal processors, tensor processing units (TPUs), graphics processing units (GPUs), application specific integrated circuits, etc.). One or more processors 1303 can be configured to execute computer-readable instructions 1306 that are contained in data storage 1304 and/or other instructions as described herein.

Data storage 1304 can include one or more non-transitory computer-readable storage media that can be read and/or accessed by at least one of one or more processors 1303. The one or more computer-readable storage media can include volatile and/or non-volatile storage components, such as optical, magnetic, organic or other memory or disc storage, which can be integrated in whole or in part with at least one of one or more processors 1303. In some examples, data storage 1304 can be implemented using a single physical device (e.g., one optical, magnetic, organic or other memory or disc storage unit), while in other examples, data storage 1304 can be implemented using two or more physical devices.

Data storage 1304 can include computer-readable instructions 1306 and perhaps additional data. In some examples, data storage 1304 can include storage required to perform at least part of the herein-described methods, scenarios, and techniques and/or at least part of the functionality of the herein-described devices and networks. In some examples, data storage 1304 can include storage for a trained neural network model 1312 (e.g., a model of trained neural networks such as neural network models described herein). In particular of these examples, computer-readable instructions 1306 can include instructions that, when executed by one or more processors 1303, enable computing device 1300 to provide for some or all of the functionality of trained neural network model 1312.

In some examples, computing device 1300 can include one or more camera(s) 1318. Camera(s) 1318 can include one or more image capture devices, such as still and/or video cameras, equipped to capture light and record the captured light in one or more images; that is, camera(s) 1318 can generate image(s) of captured light. The one or more images can be one or more still images and/or one or more images utilized in video imagery. Camera(s) 1318 can capture light and/or electromagnetic radiation emitted as visible light, infrared radiation, ultraviolet light, and/or as one or more other frequencies of light.

In some examples, computing device 1300 can include one or more sensors 1320. Sensors 1320 can be configured to measure conditions within computing device 1300 and/or conditions in an environment of computing device 1300 and provide data about these conditions. For example, sensors 1320 can include one or more of: (i) sensors for obtaining data about computing device 1300, such as, but not limited to, a thermometer for measuring a temperature of computing device 1300, a battery sensor for measuring power of one or more batteries of power system 1322, and/or other sensors measuring conditions of computing device 1300; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1300, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1300, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1300, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1320 are possible as well.

Power system 1322 can include one or more batteries 1324 and/or one or more external power interfaces 1326 for providing electrical power to computing device 1300. Each battery of the one or more batteries 1324 can, when electrically coupled to the computing device 1300, act as a source of stored electrical power for computing device 1300. One or more batteries 1324 of power system 1322 can be configured to be portable. Some or all of one or more batteries 1324 can be readily removable from computing device 1300. In other examples, some or all of one or more batteries 1324 can be internal to computing device 1300, and so may not be readily removable from computing device 1300. Some or all of one or more batteries 1324 can be rechargeable. For example, a rechargeable battery can be recharged via a wired connection between the battery and another power supply, such as by one or more power supplies that are external to computing device 1300 and connected to computing device 1300 via the one or more external power interfaces. In other examples, some or all of one or more batteries 1324 can be non-rechargeable batteries.

One or more external power interfaces 1326 of power system 1322 can include one or more wired-power interfaces, such as a USB cable and/or a power cord, that enable wired electrical power connections to one or more power supplies that are external to computing device 1300. One or more external power interfaces 1326 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1326, computing device 1300 can draw electrical power from the external power source the established electrical power connection. In some examples, power system 1322 can include related sensors, such as battery sensors associated with the one or more batteries or other types of electrical power sensors.

### Cloud-Based Servers

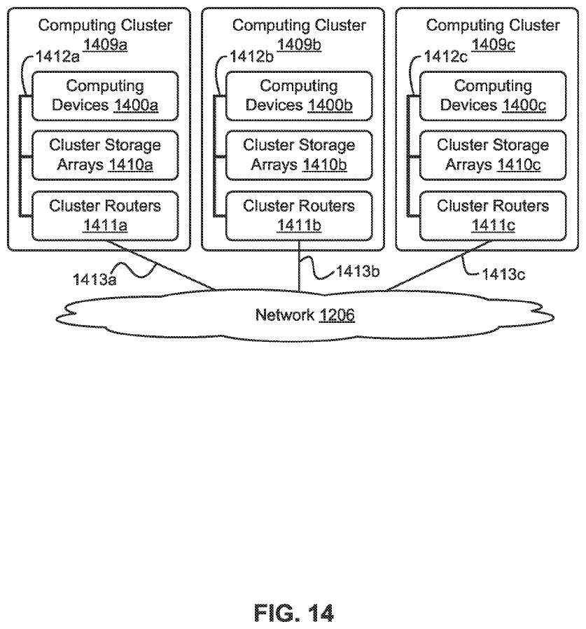

FIG. 14 depicts a cloud-based server system in accordance with an example embodiment. In FIG. 6, functionality of a neural network, and/or a computing device can be distributed among computing clusters 1409a, 1409b, 1409c. Computing cluster 1409a can include one or more computing devices 1400a, cluster storage arrays 1410a, and cluster routers 1411a connected by a local cluster network 1412a. Similarly, computing cluster 1409b can include one or more computing devices 1400b, cluster storage arrays 1410b, and cluster routers 1411b connected by a local cluster network 1412b. Likewise, computing cluster 1409c can include one or more computing devices 1400c, cluster storage arrays 610c, and cluster routers 1411c connected by a local cluster network 1412c.

In some embodiments, computing clusters 1409a, 1409b, 1409c can be a single computing device residing in a single computing center. In other embodiments, computing clusters 1409a, 1409b, 1409c can include multiple computing devices in a single computing center, or even multiple computing devices located in multiple computing centers located in diverse geographic locations. For example, FIG. 14 depicts each of computing clusters 1409a, 1409b, 1409c residing in different physical locations.

In some embodiments, data and services at computing clusters 1409a, 1409b, 1409c can be encoded as computer readable information stored in non-transitory, tangible computer readable media (or computer readable storage media) and accessible by other computing devices. In some embodiments, computing clusters 1409a, 1409b, 1409c can be stored on a single disk drive or other tangible storage media, or can be implemented on multiple disk drives or other tangible storage media located at one or more diverse geographic locations.

In some embodiments, each of computing clusters 1409a, 1409b, and 1409c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1409a, for example, computing devices 1400a can be configured to perform various computing tasks of a conditioned, axial self-attention based neural network, and/or a computing device. In one embodiment, the various functionalities of a neural network, and/or a computing device can be distributed among one or more of computing devices 1400a, 1400b, 1400c. Computing devices 1400b and 1400c in respective computing clusters 1409b and 1409c can be configured similarly to computing devices 1400a in computing cluster 1409a. On the other hand, in some embodiments, computing devices 1400a, 1400b, and 1400c can be configured to perform different functions.

In some embodiments, computing tasks and stored data associated with a neural network, and/or a computing device can be distributed across computing devices 1400a, 1400b, and 1400c based at least in part on the processing requirements of a neural network, and/or a computing device, the processing capabilities of computing devices 1400a, 1400b, 1400c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 1410a, 1410b, 1410c of computing clusters 1409a, 1409b, 1409c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a conditioned, axial self-attention based neural network, and/or a computing device can be distributed across computing devices 1400a, 1400b, 1400c of computing clusters 1409a, 1409b, 1409c, various active portions and/or backup portions of these components can be distributed across cluster storage arrays 1410a, 1410b, 1410c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 1411a, 1411b, 1411c in computing clusters 1409a, 1409b, 1409c can include networking equipment configured to provide internal and external communications for the computing clusters. For example, cluster routers 1411a in computing cluster 1409a can include one or more internet switching and routing devices configured to provide (i) local area network communications between computing devices 1400a and cluster storage arrays 1410a via local cluster network 1412a, and (ii) wide area network communications between computing cluster 1409a and computing clusters 1409b and 1409c via wide area network link 1413a to network 1206. Cluster routers 1411b and 1411c can include network equipment similar to cluster routers 1411a, and cluster routers 1411b and 1411c can perform similar networking functions for computing clusters 1409b and 1409b that cluster routers 1411a perform for computing cluster 1409a.

In some embodiments, the configuration of cluster routers 1411a, 1411b, 1411c can be based at least in part on the data communication requirements of the computing devices and cluster storage arrays, the data communications capabilities of the network equipment in cluster routers 1411a, 1411b, 1411c, the latency and throughput of local cluster networks 1412a, 1412b, 1412c, the latency, throughput, and cost of wide area network links 1413a, 1413b, 1413c, and/or other factors that can contribute to the cost, speed, fault-tolerance, resiliency, efficiency and/or other design criteria of the moderation system architecture.

### Example Methods of Operation

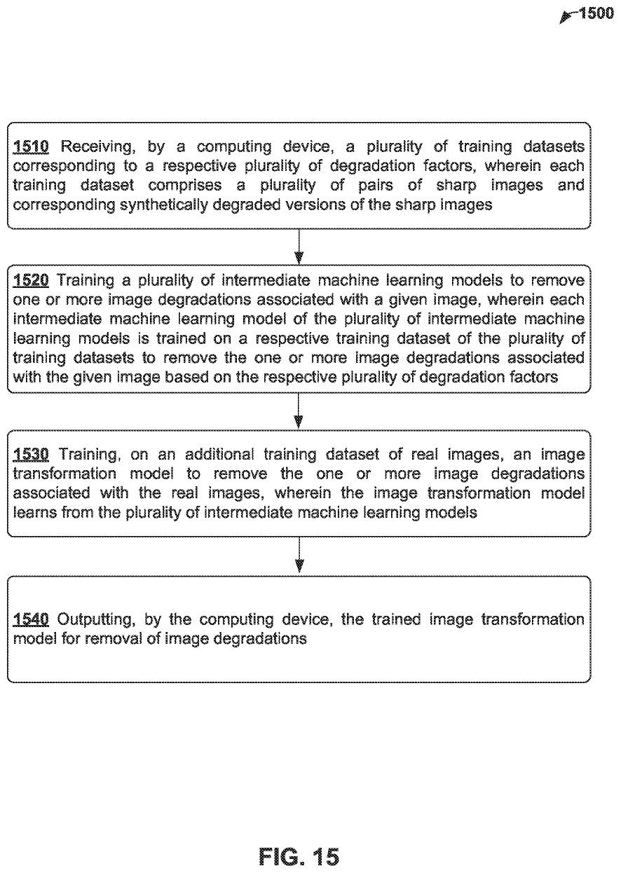

FIG. 15 is a flowchart of a method 1500, in accordance with example embodiments. Method 1500 can be executed by a computing device, such as computing device 1300.

Method 1500 can begin at block 1510, where the method involves receiving, by a computing device, a plurality of training datasets corresponding to a respective plurality of degradation factors, wherein each training dataset comprises a plurality of pairs of sharp images and corresponding synthetically degraded versions of the sharp images.

At block 1520, the method involves training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors.

At block 1530, the method involves training, on an additional training dataset of real images, an image transformation model to remove the one or more image degradations associated with the real images, wherein the image transformation model learns from the plurality of intermediate machine learning models.

At block 1540, the method involves outputting, by the computing device, the trained image transformation model for removal of image degradations.

In some embodiments, each intermediate machine learning model of the plurality of intermediate machine learning models may include an encoder-decoder neural network with skip connections, wherein the given image may be processed at different scales, wherein an output of a given scale may be upsampled and concatenated with an input of a successive scale.

In some embodiments, each intermediate machine learning model may include: (1) one or more space-to-depth (s2d) layers, wherein each s2d layer enables low-resolution processing by taking an input, reducing a spatial resolution for the input while increasing a number of channels to preserve information; and (2) one or more depth-to-space (d2s) layers corresponding to the one or more s2d layers.

In some embodiments, each intermediate machine learning model of the plurality of intermediate machine learning models is associated with a respective number of filters, and a respective space-to-depth parameter.

Some embodiments involve applying the plurality of trained intermediate machine learning models to a given real image of the additional training dataset of real images to generate corresponding output images. Such embodiments involve selecting, from the generated output images, an optimally transformed version of the given real image. Such embodiments also involve generating a curated dataset comprising pairs of real images and corresponding optimally transformed versions of the real images. In some embodiments, the applying of the plurality of trained intermediate machine learning models to the given real image involves applying each trained intermediate machine learning model at multiple resolutions. In some embodiments, the training of the image transformation model involves fine-tuning the image transformation model based on the curated dataset. In such embodiments, the fine-tuning of the image transformation model involves Quantized Aware Training (QAT).

Some embodiments involve generating the synthetically degraded versions of the sharp images.

In some embodiments, the plurality of degradation factors include a motion blur. Such embodiments involve generating one or more motion kernels that simulate camera-shake due to hand-tremor, wherein an amount of the motion blur is associated with a scale parameter related to exposure time.

In some embodiments, the plurality of degradation factors include a lens blur. Such embodiments involve generating one or more generalized Gaussian blur kernels that simulate the lens blur.

In some embodiments, the plurality of degradation factors include one or more of additive noise, signal dependent noise, or colored noise.

In some embodiments, the plurality of degradation factors include one or more image compression artifacts.

In some embodiments, the plurality of degradation factors include one or more artifacts caused by saturated pixels. Such embodiments involve determining whether a pixel value exceeds a saturation threshold. Such embodiments also involve, based on a determination that the pixel value exceeds the saturation threshold, multiplying the pixel value by a random factor.

In some embodiments, the plurality of intermediate machine learning models may be teacher networks, wherein the image transformation model may be a student network, and wherein the image transformation model learns from the plurality of intermediate machine learning models based on knowledge distillation.

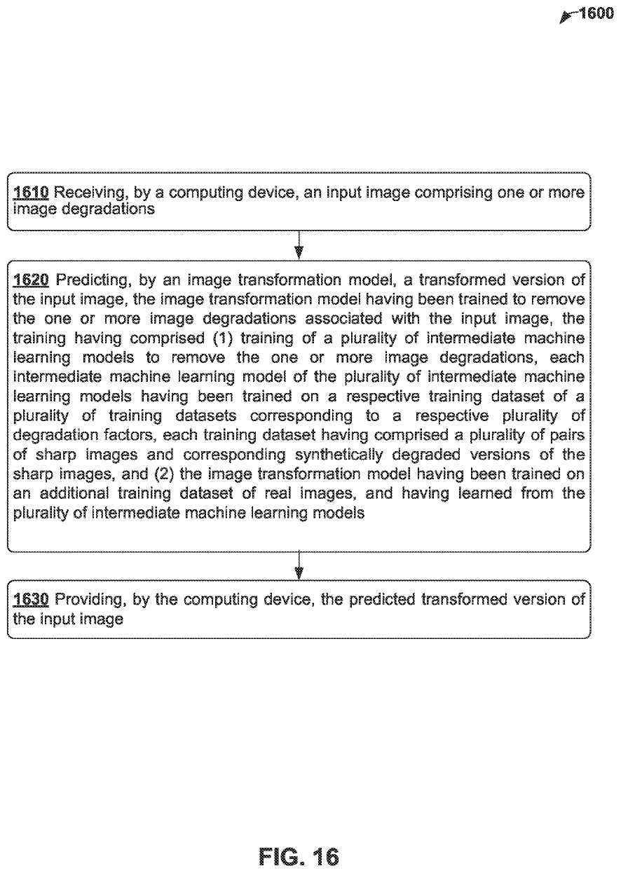

FIG. 16 is a flowchart of a method 1600, in accordance with example embodiments. Method 1600 can be executed by a computing device, such as computing device 1300.

Method 1600 can begin at block 1610, where the method involves receiving, by a computing device, an input image comprising one or more image degradations.

At block 1620, the method involves predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models.

At block 1630, the method involves providing, by the computing device, the predicted transformed version of the input image.

In some embodiments, each intermediate machine learning model of the plurality of intermediate machine learning models may include an encoder-decoder neural network with skip connections, wherein the given image may be processed at different scales, wherein an output of a given scale may be upsampled and concatenated with an input of a successive scale.

In some embodiments, the image transformation model includes an encoder-decoder neural network with skip connections, and the image transformation model further comprises: (1) one or more space-to-depth (s2d) layers, wherein each s2d layer enables low-resolution processing by taking an input, reducing a spatial resolution for the input while increasing a number of channels to preserve information; and (2) one or more depth-to-space (d2s) layers corresponding to the one or more s2d layers.

In some embodiments, the plurality of degradation factors comprise one or more of a motion blur, a lens blur, an image noise, an image compression artifact, or an artifact caused by saturated pixels.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being associated with the following claims.

1. A computer-implemented method, comprising:
receiving, by a computing device, a plurality of training datasets corresponding to a respective plurality of degradation factors, wherein each training dataset comprises a plurality of pairs of sharp images and corresponding synthetically degraded versions of the sharp images;
training a plurality of intermediate machine learning models to remove one or more image degradations associated with a given image, wherein each intermediate machine learning model of the plurality of intermediate machine learning models is trained on a respective training dataset of the plurality of training datasets to remove the one or more image degradations associated with the given image based on the respective plurality of degradation factors;
training, on an additional training dataset of real images, an image transformation model to remove the one or more image degradations associated with the real images, wherein the image transformation model learns from the plurality of intermediate machine learning models; and
outputting, by the computing device, the trained image transformation model for removal of image degradations.

2. The computer-implemented method of claim 1, wherein each intermediate machine learning model of the plurality of intermediate machine learning models comprises an encoder-decoder neural network with skip connections, wherein the given image is processed at different scales, wherein an output of a given scale is upsampled and concatenated with an input of a successive scale.

3. The computer-implemented method of claim 2, wherein each intermediate machine learning model further comprises: (1) one or more space-to-depth (s2d) layers, wherein each s2d layer enables low-resolution processing by taking an input, reducing a spatial resolution for the input while increasing a number of channels to preserve information; and (2) one or more depth-to-space (d2s) layers corresponding to the one or more s2d layers.

4. The computer-implemented method of claim 1, wherein each intermediate machine learning model of the plurality of intermediate machine learning models is associated with a respective number of filters, and a respective space-to-depth parameter.

5. The computer-implemented method of claim 1, further comprising:
applying the plurality of trained intermediate machine learning models to a given real image of the additional training dataset of real images to generate corresponding output images;
selecting, from the generated output images, an optimally transformed version of the given real image; and
generating a curated dataset comprising pairs of real images and corresponding optimally transformed versions of the real images.

6. The computer-implemented method of claim 5, wherein the applying of the plurality of trained intermediate machine learning models to the given real image comprises applying each trained intermediate machine learning model at multiple resolutions.

7. The computer-implemented method of claim 5, wherein the training of the image transformation model comprises fine-tuning the image transformation model based on the curated dataset.

8. The computer-implemented method of claim 7, wherein the fine-tuning of the image transformation model comprises Quantized Aware Training (QAT).

9. The computer-implemented method of claim 1, further comprising:
generating the synthetically degraded versions of the sharp images.

10. The computer-implemented method of claim 9, wherein the plurality of degradation factors comprise a motion blur, and the generating further comprises:
generating one or more motion kernels that simulate camera-shake due to hand-tremor, wherein an amount of the motion blur is associated with a scale parameter related to exposure time.

11. The computer-implemented method of claim 9, wherein the plurality of degradation factors comprise a lens blur, and the generating further comprises:
generating one or more generalized Gaussian blur kernels that simulate the lens blur.

12. The computer-implemented method of claim 9, wherein the plurality of degradation factors comprise one or more of additive noise, signal dependent noise, or colored noise.

13. The computer-implemented method of claim 9, wherein the plurality of degradation factors comprise one or more image compression artifacts.

14. The computer-implemented method of claim 9, wherein the plurality of degradation factors comprise one or more artifacts caused by saturated pixels, and the generating further comprises:
determining whether a pixel value exceeds a saturation threshold; and
based on a determination that the pixel value exceeds the saturation threshold, multiplying the pixel value by a random factor.

15. The computer-implemented method of claim 1, wherein the plurality of intermediate machine learning models are teacher networks, wherein the image transformation model is a student network, and wherein the image transformation model learns from the plurality of intermediate machine learning models based on knowledge distillation.

16. A computer-implemented method, comprising:
receiving, by a computing device, an input image comprising one or more image degradations;
predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models;
providing, by the computing device, the predicted transformed version of the input image.

17. The computer-implemented method of claim 16, wherein each intermediate machine learning model of the plurality of intermediate machine learning models comprises an encoder-decoder neural network with skip connections, wherein the given image is processed at different scales, wherein an output of a given scale is upsampled and concatenated with an input of a successive scale.

18. The computer-implemented method of claim 16, wherein the image transformation model comprises an encoder-decoder neural network with skip connections, and the image transformation model further comprises: (1) one or more space-to-depth (s2d) layers, wherein each s2d layer enables low-resolution processing by taking an input, reducing a spatial resolution for the input while increasing a number of channels to preserve information; and (2) one or more depth-to-space (d2s) layers corresponding to the one or more s2d layers.

19. The computer-implemented method of claim 16, wherein the plurality of degradation factors comprise one or more of a motion blur, a lens blur, an image noise, an image compression artifact, or an artifact caused by saturated pixels.

20. A computing device, comprising:
one or more processors; and
data storage, wherein the data storage has stored thereon computer-executable instructions that, when executed by the one or more processors, cause the computing device to carry out operations comprising:
receiving, by the computing device, an input image comprising one or more image degradations;
predicting, by an image transformation model, a transformed version of the input image, the image transformation model having been trained to remove the one or more image degradations associated with the input image, the training having comprised (1) training of a plurality of intermediate machine learning models to remove the one or more image degradations, each intermediate machine learning model of the plurality of intermediate machine learning models having been trained on a respective training dataset of a plurality of training datasets corresponding to a respective plurality of degradation factors, each training dataset having comprised a plurality of pairs of sharp images and corresponding synthetically degraded versions of the sharp images, and (2) the image transformation model having been trained on an additional training dataset of real images, and having learned from the plurality of intermediate machine learning models;
providing, by the computing device, the predicted transformed version of the input image.
